(19) United States
(12) Patent Application Publication
(10) Pub. No.: US 2024/0144473 A1
(43) Pub. Date: May 2, 2024

(54) Method and System for Automated Characterisation of Images Obtained Using a Medical Imaging Modality

(71) Applicant: King's College London, London (GB)

(72) Inventors: Reza Razavi, London (GB); Andrew P. King, London (GB); Bram Ruijsink, London (GB); Esther Puyol Anton, London (GB)

(21) Appl. No.: 18/277,249

(22) PCT Filed: Feb. 11, 2022
(86) PCT No.: PCT/GB2022/050374

§ 371 Date: Aug. 15, 2023

(30) Foreign Application Priority Data
Feb. 15, 2021 (GB) 2102119.1

(51) Int. Cl. G06T 7/00; G06V 10/82

(52) U.S. Cl. CPC G06T 7/0012; G06V 10/82; G06T 2207/10088; G06T 2207/20081; G06T 2207/20084; G06T 2207/30048; G06V 2201/031; G06V 2201/10

(57) ABSTRACT

The present disclosure relates to a method for automated characterisation of images obtained using a medical imaging modality, in particular, the present disclosure relates to a method for analysis of cine cardiac magnetic resonance (CMR) images using an artificial intelligence (AI) framework.

### FIELD OF DISCLOSURE

The present disclosure relates to a method for automated characterisation of images obtained using a medical imaging modality, in particular, the present disclosure relates to a method for analysis of cine cardiac magnetic resonance (CMR) images using an artificial intelligence (AI) framework.

### BACKGROUND

Cardiac magnetic resonance (CMR) is the state-of-the-art clinical tool to assess cardiac morphology, function, and tissue characterization [1], and both European and American guidelines advocate its use to diagnose and monitor a large number of cardiovascular diseases [2,3]. The role of CMR continues to grow due to the technical advances that grant increasingly detailed analysis of the cardiovascular system, including detailed analysis of cardiac morphology, myocardial deformation, ventricular volume change and myocardial tissue characterization.

However, systematic manual analysis of the different CMR sequences is highly time consuming, where the bulk of the time is taken up by repetitive tasks, such as image identification, selection, and segmentation, which are at the basis of CMR post-processing.

Deep learning (DL), a branch of artificial intelligence (AI), is securing an emergent role in the field of CMR, as it provides for automatization of repetitive tasks, significantly reducing the time required for image analysis, while maintaining high degree of accuracy [7,8]. Physicians' time can thus be optimized and funnelled for critical review of clinical and imaging information to reach a correct diagnosis.

Automated analysis also allows access to biomarkers of cardiac function that would normally be too labour intensive to obtain, such as peak ejection and filling rates from ventricular volume curves [19,20] or atrioventricular valve planar motion from long-axis segmentations.

Previous studies have disclosed implementation of DL in the analysis of CMR, including segmentation of cine images to derive cardiac function [8], analysis of perfusion defects to detect inducible ischemia [9], and assessment of late gadolinium enhancement and T1 mapping to aid tissue characterization [10,11].

Techniques for automated QC have been previously proposed, such as motion artefact detection in brain magnetic resonance imaging (20), image quality evaluation in fetal (21) and cardiac (22) ultrasound, and detection of missing slices (23), off-axis planning (24), or segmentation errors (25) in CMR. However, these techniques have been aimed at a single source of error and lack a generalized QC of the output based on clinical criteria. In a previous study by the inventors, the inventors have disclosed the possibility of implementing quality-control into a DL pipeline for automated analysis of cine CMR images [8].

There is still a need for systematic implementation of DL algorithms, prior to analysis in CMR, to improve the robustness and efficiency of image selection for analysis.

### SUMMARY OF DISCLOSURE

The present disclosure relates to a computer-implemented method and a corresponding system for automated characterisation of images obtained using a medical imaging modality, in particular, the present disclosure relates to a method for analysis of cine cardiac magnetic resonance (CMR) images using an artificial intelligence (AI) framework.

The method provided by the present disclosure enables comprehensive automated analysis of images obtained using a medical imaging modality—in particular, the method includes robust quality control (QC) mechanisms which allow for automated classification and selection of target images without clinician oversight.

The method is compatible for analysis of images obtained with any medical imaging modality such as: radiography, fluoroscopy, angiography, mammography, computed tomography, ultrasound and magnetic resonance imaging (MRI). More specifically, the method of the present disclosure could be used for analysis of medical imaging data that comprises moving targets, and/or where predefined image plane orientations are key to obtain accurate measurements, and/or image artefacts could impact measurements. For example, the proposed method could be used for analysis of medical imaging data obtained from fetal imaging, cardiac ultrasound, cardiac CT and target lesion segmentation in radiotherapy.

Analysis of images obtained using cine CMR is one important application of the present method and the present disclosure includes technical details and empirical results of the present method when used for analysis of images obtained using cine CMR. When used for analysis of cine CMR images, the present method enables the analysis of cardiac function (such as cardiac volumes, filling and ejection dynamics and myocardial strain) with higher accuracy and efficiency. In particular, the method of the present disclosure provides a framework for automated identification and quality-controlled (QC) selection of cine images from routine clinical CMR exams. This QC framework is then integrated with a larger pipeline for QC CMR analysis of cine images. Using the method of the present disclosure, reference values are provided for a range of automatically derived cardiac metrics that have not previously been reported in large subject cohorts.

Prior art methods use a single quality control step based on metrics obtained directly from segmentation of cine images. Compared to methods in the prior art, the QC framework of the present method is advantageous as, firstly, it can be independent of the segmentation process. Secondly, the method of the present invention provides a comprehensive pre- and post-analysis QC framework that allows for identification of all errors independent of their sources, thereby providing a generalisable QC framework for clinical applications. This is in contrast to prior art methods where the quality control only focusses on a single source of errors.

The present method also improves upon a previously developed method [8] by the inventors by enabling view classification and quality control of classified images and providing a fully comprehensive post-analysis QC framework which accounts for orientation and expected size of segmentation, expected volume changes between the different cardiac chambers etc., enabling the detection of errors independent of the source.

The present method enables integrated classification of image plane views, analysis, and quality control that is comprehensive and independent of the source of errors.

The present method also enables direct in-line implementation of the technique during acquisition of images on the scanner, resulting in real-time framework of looped image acquisition, analysis, quality control and adaption of the image acquisition process (based on a comprehensive quality control), thereby enabling the automation of CMR acquisition and analysis and providing robust and reproducible imaging.

According to a first aspect of this disclosure, there is provided a computer-implemented method for characterizing images of a target area of the internal anatomy of a human or animal subject, the images having been obtained using a medical imaging modality, the method comprising: providing a plurality of images of the target area obtained using the medical imaging modality; performing a first quality control check on the plurality of images, wherein the quality control check comprises: (i) classifying the plurality of images into one or more classes based on predefined metadata associated with each image; and (ii) screening the classified images, based on image quality and image orientation, to select a first set of images for analysis, wherein the method further comprises analysing the selected first set of images to evaluate one or more characteristics associated with the said target area as discernible from the selected first set of images, and wherein the method comprises the use of one or more deep learning (DL) algorithms.

According to a second aspect of this disclosure, there is provided a system for characterizing images of a target area of the internal anatomy of a human or animal subject, the images having been obtained using a medical imaging modality, wherein the system comprises a processor configured to execute a method as described in the first aspect of this disclosure.

### BRIEF DESCRIPTION OF THE DRAWINGS

FIG. 1 shows a flow chart of the proposed method 100 for analysis of images obtained using a medical imaging modality, according to an embodiment of this disclosure.

FIG. 2 shows a flow chart of the developed QC1 framework when used for selection of images obtained using cine CMR, according to an embodiment of this disclosure.

FIG. 3 is a flow chart of a method 300, according to an embodiment of this disclosure, when used for analysis of cine CMR images.

FIG. 4 shows an example system 400, according to another embodiment of this disclosure, for implementing the method as described in the other embodiments of this disclosure.

FIG. 5 shows an example visual representation of a comparison between manual and automated classification.

FIG. 6 is a diagrammatic representation of an example implementation of the pre-analysis QC framework or QC1 framework.

FIG. 7 shows the method 300 in FIG. 3 and additionally shows example images obtained using cine CMR and the segmented output image data which has also been subjected to the post-analysis QC step.

FIG. 8 shows further improvements to the flow as shown in FIG. 7 when nnU-net network has been used for the analysis step.

FIGS. 9 to 14 illustrate Figures from the Appendices.

### DETAILED DESCRIPTION

The present disclosure relates to a computer-implemented method and a corresponding system for automated characterisation of images obtained using a medical imaging modality, in particular, the present disclosure relates to a method for analysis of cine cardiac magnetic resonance (CMR) images using an artificial intelligence (AI) framework.

Conventional AI-based algorithms are typically trained for a specific input domain (for example, a specific scanner manufacturer/model and acquisition protocol) which consequently results in a loss of robustness when applied to data from other input domains. The present disclosure on the other hand aims to provide a generalised image analysis method capable of automatic quality-controlled image selection and analysis of images obtained using a medical imaging modality—the inventors aim to generalise this method such that it is not restricted to input data by specific manufacturers/models of the imaging technology.

The proposed method includes a pre-analysis quality control (QC) step and an analysis step. The method may also include a post-analysis QC step. The pre-analysis QC step is configured to automatically select target images for analysis.

Image selection is particularly important when multiple images of the same type are available, as it represents another time-consuming, but relatively simple task. Moreover, it is possible that a clinician doesn't recognize that an image was re-acquired later in the study and selects the first one, which could be of worse quality. The proposed method addresses these drawbacks and provides an automated, robust, solution for pre-analysis QC step which, when introduced in a larger pipeline for automated analysis of images, enables improved efficiency and accuracy of the analysis.

In the proposed method, as part of the pre-analysis QC step, the target images are first classified using a trained deep learning (DL) algorithm into groups based on predefined image metadata. This predefined metadata could be related, for example, to technical aspects of the medical imaging modality being used. For example, as will be described later in the description, for images obtained using cine CMR, the automated classification could be based on the different cardiac imaging planes such as 2-chamber view, 4-chamber view, short-axis and long-axis.

Conventionally, classification of images is performed manually by a clinician and is a time-consuming process. Moreover, it is also prone to human error in that it is possible that a clinician doesn't recognize that an image was re-acquired in a cine CMR sequence and selects a first instance of the image, which could be of worse quality than a subsequent instance of the same image.

The inventors have proposed to improve the quality and efficiency of the image selection process by firstly enabling automated classification of the obtained images using, for example, a trained DL algorithm. Secondly, the pre-analysis QC step of the present method is further configured to screen images from each class based on image orientation and image quality, to select images for the automated analysis. In this way, a robust automated QC step has been provided, as part of the method of this disclosure, for improving the overall efficiency and accuracy of the pipeline for automated characterisation of images obtained using a medical imaging modality, for example, using cine CMR.

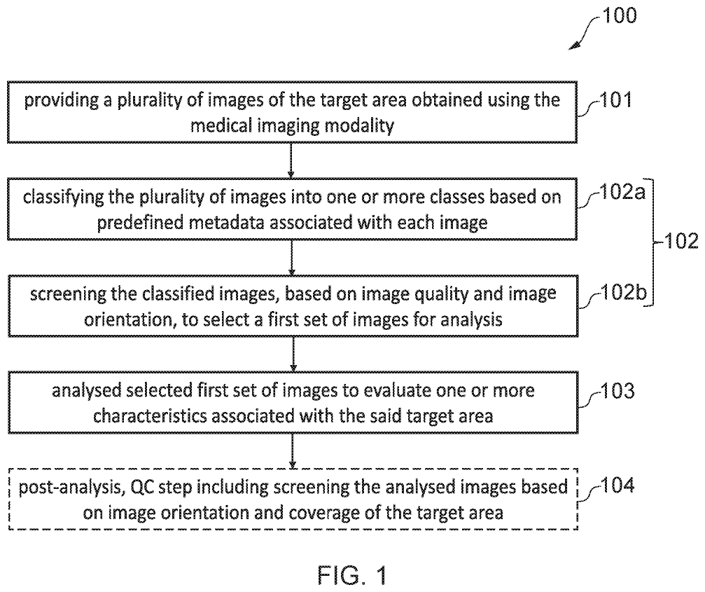

FIG. 1 shows a flow chart of the proposed method 100 according to an embodiment of this disclosure. As seen in this figure, the method comprises providing a plurality of images of the target area obtained using the medical imaging modality (step 101). The method then comprises performing a first QC check on the plurality of images (step 102), wherein the QC check comprises: (i) classifying the plurality of images into one or more classes based on predefined metadata associated with each image (step 102a); and (ii) screening the classified images, based on image quality and image orientation, to select a first set of images for analysis (Step 102b). The selected first set of images are then analysed to evaluate one or more characteristics associated with the said target area as discernible from the selected first set of images (Step 103). The method may optionally further comprise a second, post-analysis, QC step including screening the analysed images based on image orientation and coverage of the target area (Step 104).

The screening based the image orientation is defined according to the type of medical imaging modality used—for example, as will be explained later in the description, for images obtained using cine CMR, the screening based on image orientation would comprise screening the classified images for off-axis orientation where the reference axis would typically be the long axis of the left ventricle of the heart of a human or animal subject. Off axis orientations in cine CMR images could be detected, for example, by the presence of left ventricular outflow tract obstruction (LVOT) in 4-Chamber view, foreshortening of the apex, absence of any of the valves in 3-Chamber view etc. The screening based on image quality prior to analysis is based on motion artefacts—for images obtained using ultrasound for example, motion artefacts can be caused due to voluntary or involuntary patient movements; for images obtained using cine CMR, as will be explained later in the description, motion artefacts could be due to mis-triggering, breathing and implant or fold-over artefacts which hinder the detection of myocardial borders.

A detailed explanation of the method when used for analysis of images using cine CMR will be presented below.

### Image Analysis Method for Analysis of Cine CMR Images

The developed image analysis pipeline consists of a DL algorithm for segmentation of short-axis (SAX) and 2- and 4-chamber long-axis (LAX) cine CMR stacks, automated calculation of cardiac functional parameters and two QC steps: one before the segmentation and analysis steps (QC1) and one after (QC2).

### Pre-analysis Image QC or QC1

All CMR images were screened for the presence of motion artefacts (artefacts due to, for example, inconsistent breath-holding, mis-triggering or arrhythmias) and erroneous view image planning of the 4-chamber.

The inventors developed the QC1 step to include a framework for automated detection and quality-controlled selection of standard cine sequence images from routine clinical CMR exam.

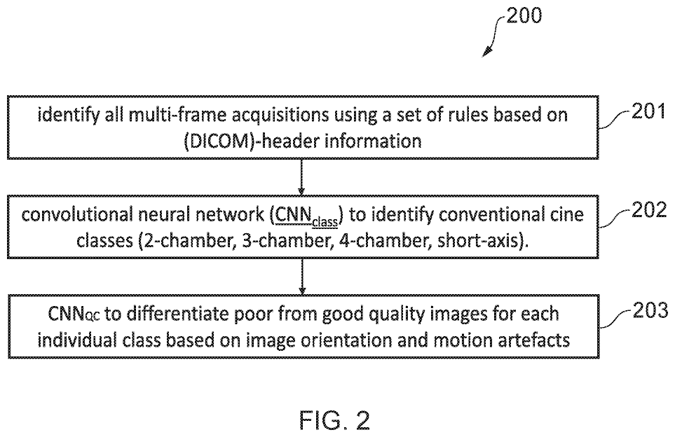

FIG. 2 shows a flow chart of the developed QC1 framework when used for selection of images obtained using cine CMR, according to an embodiment of this disclosure. As seen in FIG. 2, the QC1 framework comprises three steps. Step 201 identifies all multi-frame acquisitions using a set of rules based on Digital Imaging and Communications in Medicine (DICOM)-header information. DICOM is the standard for communication and management of medical imaging and related data: a DICOM file comprises of a header and image data sets packed into a single file. Step 202 comprises a convolutional neural network (CNN_{class}) to identify conventional cine classes (2-chamber, 3-chamber, 4-chamber, short-axis). Step 202 therefore is a more detailed implementation of step 102a in FIG. 1 when the pre-analysis QC step is used for images obtained using cine CMR. Step 203 comprises of a second set of CNN's to differentiate poor from good quality images for each individual class (CNN_{QC})—a more detailed description of how good quality images are selected is given below. Step 203 therefore is a more detailed implementation of step 102b in FIG. 1 when the pre-analysis QC step is used for images obtained using cine CMR. The three steps 201-203 are integrated to select the best 2-chamber, 3-chamber, 4-chamber, and short-axis cine images from a full clinical CMR study.

While the pre-analysis QC framework is described here using a CNN network, this step of the method could also be implemented with any other suitable DL algorithm—for example, a single frame classifier such as Visual Geometry Group (VGG) classifier, ResNet or DenseNet, or other 3D CNN networks such as 3D Residual Networks or Recurrent Neural Network (RNN)-Long-Short Term Memory (LSTM).

We will now describe the training and validation of the pre-analysis QC framework, according to an embodiment of this disclosure, when implemented for selection of images obtained using cine CMR.

### Collection of Data for Training the Pre-Analysis QC Framework

First, all single-frame acquisitions were excluded from the exams based on the dicom-header information. Next, all images were cropped to a standard size of 256×256 pixels and converted to numpy arrays the neural network analysis. The remaining 20, 194 images were manually classified by an expert physician into conventional cine classes (2,905 2-Chamber, 1,171 3-Chamber, 2,963 4-Chamber, 9,112 short-axis), or a class of ‘other’ (4,043). In case of doubt, a second opinion was sought, and a decision was made by consensus.

The manually classified data was divided as follows: 80% was used for training our class detection convolutional neural networks (CNN_{class}), 10% was used for validation, and 10% for testing. We trained seven different CNN architectures for the CNN_{class} task: AlexNet, DenseNet, MobileNet, ResNet, ShuffleNet, SqueezeNet and VGG. Each network was trained for 200 epochs with cross entropy loss, to classify images in the five classes described. For training data, data augmentation was performed on-the-fly using random translations (±30 pixels), rotations (±90°), flips (50% probability) and scalings (up to 20%) to each mini-batch of images before feeding them to the network. The probability of augmentation for each of the parameters was 50%. Augmentation is the only technique used to prevent over-fitting, as other techniques were not found to improve performance and their omission contributed to a simpler network architecture.

For classification of the short axis acquisition, the following additional rules were applied after CNN_{class}: 1) the stack was composed of a minimum of 8 slices, 2) at least 2 out the 3 central images of the stack were classified as short axis by CNN_{class}.

### Training the Pre-Analysis QC Framework

In order to train the networks for QC (CNN_{QC}), a set of 2-Chamber (1,937), 3-Chamber (1,591), 4-Chamber (2,003) images from a medical database were reviewed by an expert physician and classified as ‘correct’ or ‘wrong’ based on the image quality and orientation. For image quality, images that included mis-triggering, breathing and implant or fold-over artefacts were classified as ‘wrong’ if the detection of myocardial borders was hindered. For image orientation, all off-axis orientations (i.e. presence of LVOT in 4-Chamber, fore-shortening of the apex, absence of any of the valves in 3-Chamber) were deemed ‘wrong’. In case of doubt, a second opinion was sought, and a decision was made by consensus. The resulting database consisted of 1444 ‘correct’ and 493 ‘wrong’ 2-Chamber, 1098 ‘correct’ and 493 ‘wrong’ 3-Chamber images and 1393 ‘correct’ and 610 ‘wrong’ 4-Chamber images.

The manually classified data was used to train QC networks for each class (2Ch-CNN_{QC}, 3Ch-CNN_{QC}, 4Ch-CNN_{QC}). The data was divided as follows: 80% training, 10% for validation, 10% for testing.

Again, seven CNN architectures, described in the previous section, were trained. The inventors used the same training process as described for CNN_{class} training above, with the difference that CNN_{QC} was trained as a binary classifier, i.e., two-class classification problem as opposed to five, and therefore used binary cross entropy with a logit loss function. Additionally, the inventors implemented an adaptive learning rate scheduler, which decreases the learning rate by a constant factor of 0.1 after 5 epochs stopping on plateau on the validation/test set (commonly known as ReduceLRonPlateau). This step was added as it improves CNN training when presented with unbalanced datasets.

QC of short axis acquisitions was not performed in this step, as the downstream pipeline for automated CMR analysis, already exhibits short-axis QC.

### Pre-Analysis QC Step: Validation of Framework

After training the networks as described above, a final pre-analysis QC framework was developed comprising steps 201-203 as described above with reference to FIG. 2.

To complete the framework, the CNN_{class} and CNN_{QC} were combined with a final selection algorithm. This algorithm selected one good quality acquisition of each standard cine view for image analysis, when multiple acquisitions of a single class were present in the exam. For long axis data, the above-mentioned selection of one good quality acquisition of each standard cine view for image analysis is based on selecting the case with the highest probability of being scored “correct” by the CNN_{QC}. For short axis, the above-mentioned selection of one good quality acquisition of each standard cine view for image analysis is based on selecting the stack with the highest probability of belonging to SAX (obtained from the output of the CNN_{class}). If any of the classes was absent in an exam, or the framework did not identify an image of sufficient quality, the case was flagged for clinician review.

This pre-analysis QC framework when implemented as part of a method for analysis of cine CMR images, first selects the classes using CNN_{class}, and subsequently performs quality control using the CNN_{QC}. If the CNN_{class} identified more than one acquisition for any of the classes, the image with the highest quality was selected based on the probabilities obtained by the CNN_{QC} for the long axis data. For short axis, the stack with the highest probability of belonging to short axis (obtained from the output of the CNN_{class}) was selected.

Such an automated QC framework has the advantage that it avoids any human error associated with selection of images—for example, during a manual classification and selection of images, it is possible that a clinician doesn't recognize that an image was re-acquired later in the study and selects the first one, which could be of worse quality. The automated QC framework not only classifies the images based on the cardiac imaging planes but also screens each class of images to select the image with the highest quality using a trained DL algorithm as described above. With reference to the different cardiac imaging planes, it is noted that the imaging planes are based on standard orientations used in cardiac assessment: the left ventricular 2Ch long axes, left ventricular 3Ch long axis, left ventricular 4Ch long axis and short axis orientations. If any of the classes was absent in an exam, or the framework did not identify an image of sufficient quality, the case was flagged for clinician review.

As the individual components of the developed pre-analysis QC framework act in series in the complete framework, their sequential action will yield an overall performance that is different from the sum of the individual ones. To find the best combination of components, each possible combination of the trained CNN architectures trained in the previous steps was tested using an additional test set of approximately 400 scans randomly selected from a medical database, not previously used for CNN training. For each exam, a manual operator selected the best cine long and short axis acquisitions. To determine the intra- and inter-observer variability present in the manual analysis, approximately 100 randomly selected scans were re-analyzed by the same operator and by a second operator. A complete framework was built for each possible combination of the different CNN architectures developed in the previous steps.

The integration of the three steps (201-203) of the pre-analysis QC framework yielded a safe, accurate and rapid system to select images of interest for analysis. The validation of the complete framework shows it is highly sensitive to detect erroneous images, with a 90% sensitivity for 2-Chamber, 93% for 3-Chamber, and 94% for 4-Chamber acquisitions. This is achieved at the cost of a small proportion of good quality images being mistakenly labelled as erroneous, thus requiring clinician review. However, this is a reasonable compromise as it ensures clinical safety within an automated process. Moreover, the process of review is fast in the falsely labelled data as it does only require a visual check from the clinician.

A more detailed discussion of the results of the full pipeline for analysis of cine CMR images, including the pre-analysis QC framework, is provided in a later section of this description.

For the complete framework, the inventors selected the CNN_{class} and CNN_{QC} that performed best in sequence, rather than the networks that performed best in the validation of the individual steps. This is important, as a sequential process can leverage individual strengths and weaknesses to obtain the best combined result.

### Image Analysis: Image Segmentation

After QC1, a no-new-net (nnU-net) network was used to segment the left ventricle (LV) and right ventricle (RV), including the LV myocardium, in all frames of the cine SAX and LAX sequences.

This network is trained with data from the UK Biobank (˜4000 subjects) and from the hospital (˜4000 subjects). This database included data acquired on 1.5 T Siemens and 1.5 T and 3.0 T Phillips CMR scanners using a large variety of protocols, with variable voxel- and image-sizes, acquisition techniques and under-sampling factors. Also, this database contains data from a heterogeneous population, including both healthy and pathological hearts, with a variety of cardiac pathologies (ischemic heart disease, dilated and hypertrophic cardiomyopathy, valvular heart disease, adult congenital heart disease and others). In comparison to the fully convolutional network (FCN) used in the previously disclosed pipeline [8], the no-new-net network is more suitable for use in a clinical setting as it has been trained and optimized for the largest CMR database to date. The proposed method was evaluated on randomly selected test sets from UKBB (n=488) and NHS (n=331) and on two external publicly available databases of clinical CMRs acquired on Philips, Siemens, General Electric (GE), and Canon CMR scanners—ACDC (n=100) [7] and M&Ms (n=321) [22].

From the cine aorta CMR sequences in particular, the inventors have developed a DL segmentation algorithm to segment the aorta over time and compute aortic distensibility from its segmentations. The DL segmentation algorithm can implement both a FCN network as well as a nnU-net network trained on a UK Biobank database.

### Image Analysis: Parameter Calculation

After segmentation, the SAX and LAX imaging stacks were aligned using an iterative alignment process to correct for different breath-hold positions and motion between the different cine-acquisitions (15). Next, LV and RV volume curves and LV mass

(LVM) were calculated. From the volume curves, end-diastolic volume (EDV), end-systolic volume (ESV), stroke volume (SV), EF, peak ejection rate, peak early filling rate, atrial contribution (AC), and peak atrial filling rate were obtained.

The use of a nnU-net network further enables the extension of the previously developed pipeline to include a larger set of biomarkers such as Mitral and tricuspid valve annular plane systolic excursion (MAPSE and TAPSE) and early diastolic velocities (MAPDv, TAPDv).

Subsequently, CMR feature tracking (FT) based only on segmentations to compute LV and RV global strain and early diastolic strain rates has been developed. The CMR FT uses the output of the nnU-net network to compute LV and RV global strain.

### Post-Analysis QC (QC2)

The post-analysis QC step detects any incorrect output from previous steps. To this end the inventors have defined a set of heuristic rules based on clinical knowledge followed by a machine learning-based classifier, as will be explained in more detail below.

The post-analysis QC step or QC2, takes into account the full cardiac cycle. The inventors have trained a CNN-LSTM network that takes as input the full cardiac volume and detects unphysiological curves.

The developed CNN-LSTM network combines a CNN model for feature extraction and the LSTM Model for interpreting the features across time steps. The CNN-LSTM network assess if the temporal resemblance of the ventricular volume is correct or incorrect. The ventricular volume is the volume of the ventricles over one cardiac cycle, and it is a smooth, continuous and cyclic function. More specifically, the cardiac cycle can be divided into four basic phases: ventricular filling (diastole), isovolumetric contraction (systole), ejection (systole), and isovolumetric relaxation (diastole). From health to disease, the shape and temporal evolution of the ventricular volume curve is bound by biophysical principles, resulting in a set of shapes. The developed CNN-LSTM network is able to distinguish between valid shapes of the ventricular volume curve that are bound by biophysical principles and errors in the ventricular volume curve that originate from the automated segmentation process.

The CNN-LSTM model assesses the ventricular volumes for the full cardiac cycle (around 50 time steps in a practical implementation). The LSTM model is adapted to look at the information from the closest five frames and ignore the rest. The CNN-LSTM model developed by the inventors for this step assesses a shorter temporal span with the LSTM network having a shorter memory when compared to similar architectures used elsewhere, for example in [18].

The post analysis QC step or QC2, implementing a DL algorithm, for example the CNN-LSTM network as described above, is used to: evaluate the orientation of the analysed images, detect missing slices and the coverage of the segmentations over the heart. The step includes automatic comparison of the aligned LAX (long axis) and SAX (short axis) images and segmentations to determine the image plane intersections (for example checking whether the LAX images intersect the mitral valve and apex in SAX), presence of missing slices (for example, checking whether the SAX stack cover the full length of the LAX segmentation), and the coverage of segmentations (for example, checking whether LAX segmentation reach a similar level as the SAX segmentation and vice versa). The SAX sequence is a stack of multiple 2D images (x,y; slices), stacked on top of each other over a ‘z-axis’, resulting in an coverage of the image of the heart from top (base) to bottom (apex). This coverage is vital, as missing data would result in errors in the quantification of biomarkers from the images.

Next, the output parameters were inspected. If there was a >10% difference between Left and right Ventricular Stroke Volume (SV) or a >10% difference between ventricular volumes on the first and last cardiac phase, the exams were flagged.

Lastly, two support vector machine (SVM) classification algorithms were implemented to detect abnormalities in the obtained volume (SVMᵥₒₗ) and strain curves (SVMₛₜᵣₐᵢₙ). These SVMs were trained using output of the network used for segmentation in the analysis step and FT algorithm from 500 UK Biobank subjects (300 healthy subjects and 200 subjects with cardiomyopathy). For purposes of training, these datasets were classified by an expert CMR cardiologist as right or wrong/unusual on the basis of the shape of the volume and strain curves, as well as the corresponding functional parameters. All abnormal cases detected during the QC steps were flagged for clinician review.

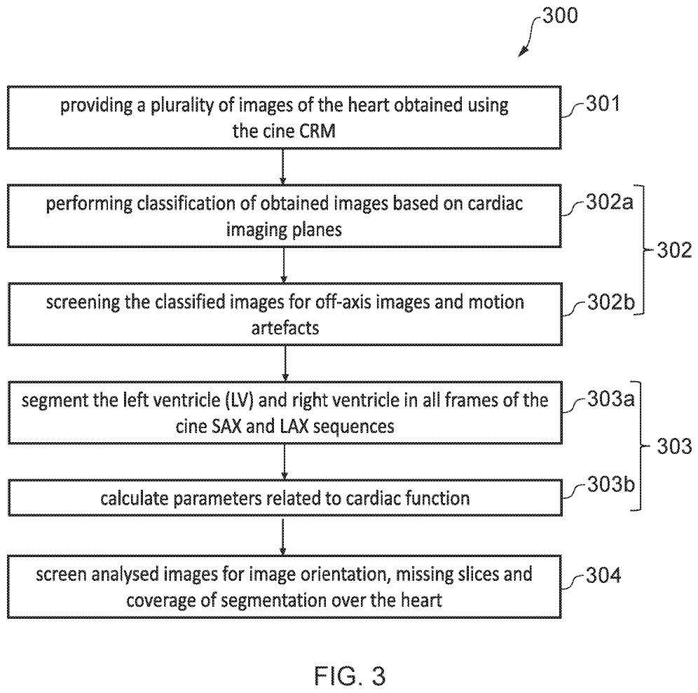

FIG. 3 is a flow chart of a method 300, according to an embodiment of this disclosure, when used for analysis of cine CMR images. This is a specific implementation of the method as described in FIG. 1. Step 301 involves providing a plurality of images of the heart, of a human or animal subject, obtained using cine CMR. The pre-analysis QC step 302 which involves performing classification based on cardiac imaging planes (step 302a) and screening the classified images, that is, screening each individual class, for off-axis images and motion artefacts (step 302b), as described in detail in the description above. The analysis step 302 comprises image segmentation using a DL algorithm (step 303a), preferably a nnU-net algorithm as described in detail above, to segment the selected high quality images from the pre-analysis QC control step—this involves segmentation of the left ventricle (LV) and right ventricle (RV), including the LV myocardium, in all frames of the cine SAX and LAX sequences. The analysis step further comprises parameter calculation after segmentation of the images (step 303b), as also described in detail above. The analysed images are then subject to a post-analysis QC step (304) which screens the analysed images for image orientation, missing slices and coverage of the segmentation over the heart, as described in detail above.

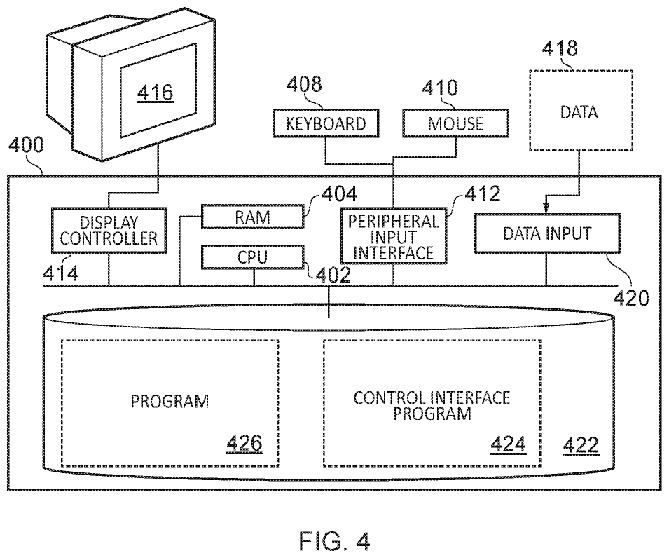

FIG. 4 shows an example system 400, according to another embodiment of this disclosure, for implementing the method as described in the other embodiments of this disclosure. FIG. 4 shows a block diagram illustrating an arrangement of a system 400 according to an embodiment of the present invention.

Some embodiments of the present invention are designed to run on general purpose desktop or laptop computers. Therefore, according to an embodiment, a computing apparatus 400 is provided having a central processing unit (CPU) 402, and random access memory (RAM) 404 into which data, program instructions, and the like can be stored and accessed by the CPU 402.

The apparatus 400 is provided with a display screen 406, and input peripherals in the form of a keyboard 408, and mouse 410. Keyboard 408, and mouse 410 communicate with the apparatus 400 via a peripheral input interface 412. Similarly, a display controller 414 is provided to control display 416, so as to cause it to display images under the control of CPU 402. Data 418, for example image files in a DICOM format obtained as output from a medical imaging modality, can be input into the apparatus 400 and stored via data input 420. In this respect, apparatus 400 comprises a computer readable storage medium 422, such as a hard disk drive, writable CD or DVD drive, zip drive, solid state drive, USB drive or the like, upon which data 418 can be stored. Alternatively, the data 418 could be stored on a web-based platform, for example, a database, and accessed via an appropriate network. Computer readable storage medium 422 also stores various programs, which when executed by the CPU 402 cause the apparatus 400 to operate in accordance with some embodiments of the present invention.

In particular, a control interface program 424 is provided, which when executed by the CPU 402 provides overall control of the computing apparatus, and in particular provides a graphical interface on the display 416, and accepts user inputs using the keyboard 408 and mouse 410 by the peripheral interface 412. Such a control interface 424 could be used in a clinical setting by a clinician to run the program with instructions for analysing the images obtained using a medical imaging modality. The control interface program 424 may also call, when necessary, other programs to perform specific processing actions when required. The user launches the control interface program 424. The control interface program 424 is loaded into RAM 404 and is executed by the CPU 402. The user then launches a program 426, which acts on the input data 418 as described above. The program instructions 426 executed by the CPU 402 relate to the method as described in any of the other embodiments of this disclosure.

We will now provide some details of empirical results obtained as a result of implementing the above method. The empirical results demonstrate that the full pipeline implementing the method of the present disclosure, including the pre-analysis QC step, is time-efficient and highly accurate, with a focus on high sensitivity, showing an improvement compared to a previously published work by the inventors [8]. In some embodiments, the developed pipeline was implemented in Python using standard libraries such as Numpy and Pandas as a dedicated deep learning library Pytorch and TensorFlow.

### Results & Discussion

### Study Population

Of the 3,827 CMR exams used for this study 3,448 were used for the training and validation of CNN_{class} and CNN_{QC} [1,026 acquisition of 16,151 (6.4%) were excluded because of grossly disruptive artifacts or grossly distorted anatomy]. These included patients undergoing clinical scans at Guy's and St. Thomas' NHS Foundation Trust (GSTFT), London, as well as subjects voluntarily enrolling onto the UK BioBank project, yielding a heterogeneous population in terms of sex (55% male) and clinical presentation (43% healthy, the remaining displaying a wide variety of cardiovascular pathologies, as shown in Table 1). The remaining 379 CMR scans were used to test the complete framework. These were all selected from the GSTFT database to obtain a population representative of routine clinical practice. Demographic characteristics are comparable to the training population, but clinical presentation was more variable, with only 18% of patients having no cardiovascular pathology. Population characteristics are summarized below in Table 1.

TABLE 1
Population characteristics.

| | | | | Complete | |
|---|---|---|---|---|---|
| | | CNN training | | framework | |
| Number | | 3,445 | | 379 | |
| Age (years) | | 57 ± 16 | | 49 ± 19 | |
| Sex (males) | | 1,911 | (55) | 228 | (60) |
| Height (cm) | | 176 ± 32 | | 171 ± 18 | |
| Weight (kg) | | 79 ± 18 | | 80 ± 19 | |
| BMI (kg/m²) | | 27 ± 5 | | 27 ± 7 | |
| Ethnicity | Caucasian | 2,401 | (69.7) | 231 | (60.9) |
| | Afro-Carribean | 172 | (5.0) | 54 | (14.2) |
| | Asian | 85 | (2.5) | 10 | (2.6) |
| | Other | 21 | (0.6) | 7 | (1.8) |
| | Not stated | 766 | (22.2) | 77 | (20.3) |
| Cardiac | Healthy | 1,886 | (54.7) | 68 | (17.9) |
| pathology | IHD | 315 | (9.1) | 43 | (11.3) |
| | DCM | 167 | (4.8) | 27 | (7.1) |
| | HCM | 77 | (2.2) | 16 | (4.2) |
| | ACHD | 185 | (5.4) | 59 | (15.6) |
| | Valvular | 133 | (3.9) | 37 | (9.8) |
| | Vascular | 104 | (3.0) | 32 | (8.4) |
| | Arrhythmic | 159 | (4.6) | 26 | (6.9) |
| | Other | 419 | (12.2) | 71 | (18.7) |

Age, sex, height, weight, and cardiac pathology of subjects used for training of CNNs, framework and full pipeline validation. All continuous values are reported as mean ± standard deviation, while categorical variables are reported as number (percentage). ACHD, adult congenital heart disease (excluding valvular and vascular abnormalities); CNN, convolutional neural network; HCM, hypertrophic cardiomyopathy; IHD, ischaemic heart disease; SD, standard deviation.

### Statistics

1. Class Identification CNN. Precision, recall, and F1-score of each class (‘4-chamber’, ‘3-chamber’, ‘2-chamber’, ‘short-axis’, ‘other’) and overall accuracy were computed at test time to evaluate performance of each trained CNNclass.
2. Quality control CNN: Precision, recall, and F1-score of each class (‘correct’, ‘wrong’) and overall accuracy were assessed to evaluate performance at test time of each trained 2Ch/3Ch/4Ch-CNNQC.
3. Framework validation Sensitivity (defined as: the percentage of incorrect cases identified as incorrect), specificity (defined as: the percentage of correct cases identified as correct), and balanced accuracy were computed for each framework. Cohen kappa coefficient was used to assess intra- and inter-observer variability.

The developed pre-analysis QC framework was added as first step of larger pipeline for analysis of cine CMR images. The larger pipeline comprised quality-controlled image segmentation and analysis of cine images to obtain LV and RV volumes and mass, LV ejection and filling dynamics, and LV longitudinal, radial and circumferential strain.

The inventors demonstrate, through these results, the feasibility and importance of a fully automated multi-step QC pipeline by running 700 cases randomly selected from their database through the developed pipeline. For the 700 cases which were run through the pipeline, the average time for selection and complete cine analysis from a full CMR study is reported, and report sensitivity, specificity and balanced accuracy of error detection is also reported.

### Pre-Analysis QC Framework

Class Identification Step

Precision, recall, F1-score, accuracy for all CNN_{class} are presented in Table 2 below. All trained architectures showed excellence performance, with accuracy ranging from 0.989 to 0.998. Densenet was the best performing network with accuracy 0.998; precision, recall and F1-score were 0.998, 1.00, 0.999 for 2-chamber, 1.00, 1.00, 1.00 for 3-chamber, 1.00, 0.998, 1.00 for 4-chamber, and 0.996, 0.999, 0.998 for short axis.

TABLE 2 [symbol]
CNN

[symbol]

| | AlexNet | | | DenseNet | | | MobileNet | | | ResNet | |
|---|---|---|---|---|---|---|---|---|---|---|---|
| | Precision | Recall | F1-score | Precision | Recall | F1-score | Precision | Recall | F1-score | Precision | Recall |
| 2- [symbol] | [symbol] | [symbol] | [symbol] | [symbol] | [symbol] | [symbol] | [symbol] | [symbol] | [symbol] | [symbol] | [symbol] |
| 3- [symbol] | [symbol] | [symbol] | [symbol] | [symbol] | [symbol] | [symbol] | [symbol] | [symbol] | [symbol] | [symbol] | [symbol] |
| 4- [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] |
| Other | [symbol] | [symbol] | [symbol] | [symbol] | [symbol] | [symbol] | [symbol] | [symbol] | [symbol] | [symbol] | [symbol] |

| | | | | |
|---|---|---|---|---|
| Accuracy | [symbol] | [symbol] | [symbol] | [symbol] |

| | ResNet | ShuffleNet | | | SqueezeNet | | | VGG | | |
|---|---|---|---|---|---|---|---|---|---|---|
| | F1-score | Precision | Recall | F1-score | Precision | Recall | F1-score | Precision | Recall | F1-score |
| 2- [symbol] | [symbol] | [symbol] | [symbol] | [symbol] | [symbol] | [symbol] | [symbol] | [symbol] | [symbol] | [symbol] |
| 3- [symbol] | [symbol] | [symbol] | [symbol] | [symbol] | [symbol] | [symbol] | [symbol] | [symbol] | [symbol] | [symbol] |
| 4- [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] |
| Other | [symbol] | [symbol] | [symbol] | [symbol] | [symbol] | [symbol] | [symbol] | [symbol] | [symbol] | [symbol] |

| | | | | |
|---|---|---|---|---|
| Accuracy | [symbol] | [symbol] | [symbol] | [symbol] |

[symbol]

indicates data missing or illegible when filed

### Quality Control Step

Precision, recall, F1-score, accuracy for all CNN_{class} are presented in Table 3 below. Accuracy was variable for different architectures and ranged from 0.751 to 0.861 for 2-chamber, from 0.690 to 0.806 for 3-chamber, and from 0.705 to 0.859 for 4-chamber. Precision, recall and F1-score was consistently lower for the ‘wrong’ class compared to the ‘correct’ class for all trained architectures and across the 3 different chamber views.

TABLE 3
Class Identification CNN_{QC} performance.

| AlexNet | | | DenseNet | | | MobileNet | | | ResNet | |
|---|---|---|---|---|---|---|---|---|---|---|
| Precision | Recall | F1-score | precision | recall | F1-score | precision | recall | F1-score | Precision | recall |

2Ch-CNN_{QC}

| | | | | | | | | | | | |
|---|---|---|---|---|---|---|---|---|---|---|---|
| Correct | [symbol] | 0.844 | 0.850 | [symbol] | 0.841 | 0.884 | 0.889 | 0.917 | [symbol] | 0.877 | 0.910 |
| Wrong | [symbol] | 0.558 | 0.547 | 0.620 | 0.806 | 0.701 | 0.714 | 0.645 | [symbol] | [symbol] | 0.602 |

| | | | | |
|---|---|---|---|---|
| Accuracy | 0.776 | [symbol] | 0.851 | 0.835 |

3Ch-CNN_{QC}

| | | | | | | | | | | | |
|---|---|---|---|---|---|---|---|---|---|---|---|
| Correct | 0.788 | 0.795 | 0.792 | 0.815 | 0.923 | 0.866 | 0.850 | 0.873 | [symbol] | 0.830 | 0.868 |
| Wrong | [symbol] | 0.525 | 0.531 | 0.757 | 0.535 | [symbol] | [symbol] | 0.857 | 0.677 | [symbol] | 0.606 |

| | | | | |
|---|---|---|---|---|
| Accuracy | 0.712 | 0.803 | [symbol] | 0.787 |

4Ch-CNN_{QC}

| | | | | | | | | | | | |
|---|---|---|---|---|---|---|---|---|---|---|---|
| Correct | 0.877 | [symbol] | [symbol] | [symbol] | [symbol] | [symbol] | [symbol] | 0.878 | 0.884 | [symbol] | 0.900 |
| Wrong | [symbol] | 0.726 | 0.675 | [symbol] | [symbol] | [symbol] | 0.719 | 0.744 | 0.731 | [symbol] | 0.701 |

| | | | | |
|---|---|---|---|---|
| Accuracy | 0.793 | [symbol] | [symbol] | [symbol] |

| | ResNet | Shufflenet | | | SqueezeNet | | | VGG | | |
|---|---|---|---|---|---|---|---|---|---|---|
| | F1-score | precision | recall | F1-score | precision | recall | F1-score | precision | recall | F1-score |
| 2Ch-CNN_{QC} | | | | | | | | | | |
| Correct | 0.893 | 0.881 | 0.869 | 0.875 | 0.755 | [symbol] | 0.858 | 0.873 | 0.955 | 0.912 |
| Wrong | 0.640 | 0.608 | 0.634 | 0.821 | 0.000 | 0.000 | 0.000 | 0.808 | 0.570 | 0.667 |
| Accuracy | 0.835 | 0.812 | | | 0.751 | | | [symbol] | | |
| 3Ch-CNN_{QC} | | | | | | | | | | |
| Correct | 0.849 | 0.880 | 0.800 | 0.838 | 0.690 | 1.000 | 0.816 | 0.824 | 0.873 | 0.848 |
| Wrong | 0.838 | 0.630 | 0.758 | 0.888 | 0.000 | 0.000 | 0.000 | 0.874 | 0.586 | [symbol] |
| Accuracy | 0.787 | 0.786 | | | 0.690 | | | [symbol] | | |
| 4Ch-CNN_{QC} | | | | | | | | | | |
| Correct | 0.888 | [symbol] | [symbol] | [symbol] | 0.705 | 1.000 | 0.827 | 0.891 | 0.878 | 0.884 |
| Wrong | 0.722 | [symbol] | 0.796 | 0.724 | 0.000 | 0.000 | 0.000 | 0.719 | 0.744 | 0.731 |

| | | | | |
|---|---|---|---|---|
| Accuracy | [symbol] | 0.821 | 0.705 | [symbol] |

[symbol]

indicates data missing or illegible when filed

### Pre-Analysis QC Step Framework: Validation

Sensitivity, specificity, and balanced accuracy of each constructed framework to identify and select one good quality 2Ch, one good quality 3Ch, and one good quality 4Ch image for each exam are shown in Table 4 below.

In this case, the results of one CNNclass, i.e., DenseNet, is presented given the very high and similar performance of all different architectures, combined with all possible CNN_{QC}'s.

TABLE 4
Framework validation

| | Framework for image Mantilication and selection | | | | | | | | |
|---|---|---|---|---|---|---|---|---|---|
| | DenseNet CNN_{class}+ | | | | | | | | |
| | 2Ch-CNN_{QC} | | | 3Ch-CNN_{QC} | | | 4Ch-CNN_{QC} | | |
| Network | SEN | SPE | BACC | SEN | SPE | BACC | SPE | SEN | BACO |
| [symbol] | 70.4 | 80.8 | 84.6 | 84.4 | 85.8 | 85.1 | 70.3 | 90.9 | 80.6 |
| [symbol] | 75.0 | 91.1 | 83.0 | 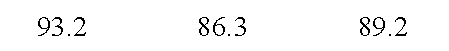 | | | 88.2 | 90.8 | 89.5 |
| [symbol] | 79.1 | 92.4 | 85.2 | 88.9 | 85.9 | 97.4 | 72.2 | 91.9 | 82.1 |
| [symbol] | 77.8 | 91.4 | 84.5 | 88.9 | 86.1 | 87.0 | 88.3 | 90.9 | 87.1 |
| [symbol] | 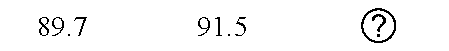 | | | 88.9 | 85.9 | 87.4 | 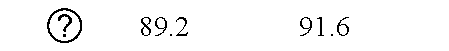 | | |
| [symbol] | [symbol] | 88.2 | 71.8 | 51.8 | 91.0 | 71.4 | 23.8 | [symbol] | 58.4 |
| [symbol] | 84.4 | 91.8 | [symbol] | 84.8 | 85.1 | 84.9 | [symbol] | 91.4 | [symbol] |

[symbol]

indicates data missing or illegible when filed

The best performing framework was: DenseNet CNN_{class}+ShuffleNet 2Ch-CNNQC (sensitivity=89.7%, specificity=91.5%, balanced accuracy=90.6%), DenseNet 2Ch-CNNQC (sensitivity=93.2%, specificity=85.3%, balanced accuracy=89.2%), ShuffleNet 4Ch-CNNQC (sensitivity=93.9%, specificity=89.2%, balanced accuracy=91.6%).

Cohen's k for intra- and inter-observer agreement for the same manual operator and between the two different operators were 0.79 and 0.60, respectively.

### Full Pipeline for Analysis of Cine CMR Images (Including Pre-Analysis QC Step)

The average time for selection and complete cine analysis from a full CMR study, using a method implemented according to the present disclosure, was between 4 and 7 minutes for a clinical CMR exam.

The sensitivity (SEN), specificity (SPE) and balanced accuracy (BACC) of the integrated pipeline in 700 cases were 96.3%, 85.0%, and 90.6% respectively. Performance was also assessed for left and right ventricle, and for healthy and pathological cases separately. Results are summarized in Table 5 below.

TABLE 5
Full pipeline performance.

| | Full pipeline | | |
|---|---|---|---|
| | BACC | SEN | SPE |
| Healthy | 92.3 | 96.5 | 88.1 |
| Pathological | 87.3 | 95.7 | 78.9 |
| Global | 90.6 | 96.3 | 85.0 |

### Discussion

The inventors have demonstrated the implementation of an automated pre-analysis QC framework to identify all conventional cine views and subsequently select those cine images that have sufficient quality for further automated image analysis. To the best of the inventors' knowledge, this is the first automated framework developed for this aim.

The framework was trained on multivendor and clinically heterogeneous data, which makes it generalizable to be implemented as the first step of other existing tools for image analysis.

Moreover, the framework was developed through training and testing of 7 state-of the art CNN architectures for each step. In DL, several network variants are available, each exhibiting different strengths and weaknesses. Studies often focus on a single highly individualized network, tailored for a task through multiple trail-and-error experiments. This makes reproduction of the methods and appreciation of its performance in the context of other datasets challenging. In this work, the inventors present the data of all trained CNN architectures, thus displaying the selection process in a reproducible, fair and meaningful way.

Finally, the developed pre-analysis QC framework is integrated as the first step of a larger pipeline for analysis of cine images and it has been demonstrated that it could produce highly accurate, rapid, and fully-automated cine analysis from a complete collection of images, routinely acquired during a clinical study.

### Pre-Analysis QC Framework

### Class Identification

Class identification is the first necessary step for image analysis, making algorithmic classification of standard views a fundamental step for true automatization of analysis [12].

Identification of conventional cine classes is time consuming, especially in long CMR studies, where multiple images are acquired. Moreover, view recognition cannot rely on the name of the sequences, as these are not replicated across groups and misnaming is common, especially when images are repeated, due to insufficient quality or slight errors in view-planning or added during acquisition.

These characteristics make the problem of class identification well suited for DL-based automatization, which is reflected in the very high performance of all trained CNN_{class} in this step. All trained architectures had an accuracy nearing 100%. Equally, precision, recall and F1-scores were mostly between 0.99 and 1 for all classes.

### Quality Control

The second DL component of the pre-analysis QC framework is trained to identify images of quality or planning inadequate for automated image analysis. That is, the second DL component of the framework is trained to add a quality-control step to the framework by identifying images of insufficient quality or inadequate planning to inform the automated image analysis process.

Quality control is crucial to transfer DL research tools to the clinical reality in a safe manner, and its importance is increasingly recognized [8,10,15,16]. To strengthen QC, this network could be extrapolated to be also used during image acquisition, so to flag unsatisfactory images to the radiographer, who may under-detect problems due to time pressure. This would improve image quality upstream and yield a greater accuracy of image analysis [17].

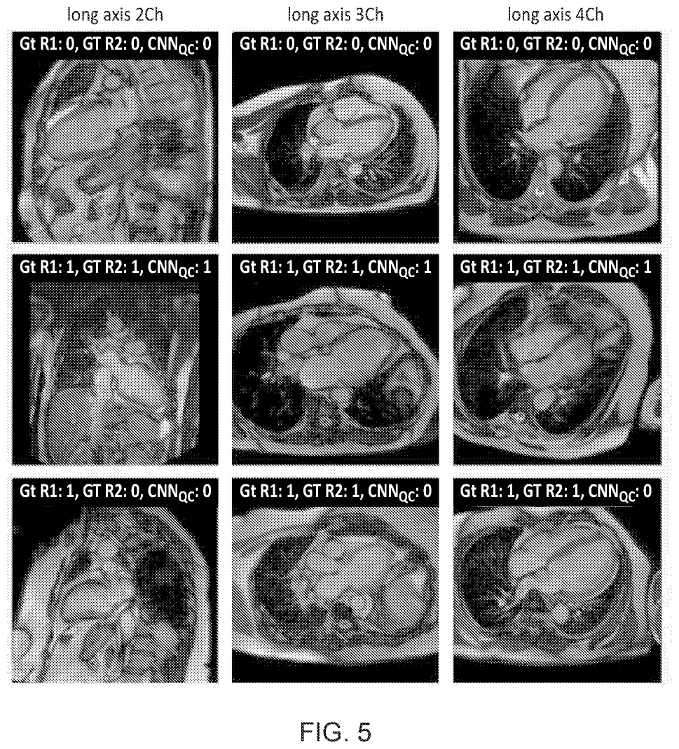

Performance of CNNQC is lower compared to the CNNclass. In particular, highest recorded accuracy was 0.86 for 2-Chamber and 4-Chamber, and 0.80 for 3-Chamber. This is explained by a number of reasons. First, there is a degree of subjectivity in this task, as a same problem can be present to a varying degree of severity; for example, the outflow tract of the left ventricle (LVOT), which should never be represented in a 4-chamber view, could be seen as a small defect in the basal most septum or could be so obvious that the image resembles a 3-chamber view. The subjectivity of this task is reflected in the intra- and inter-observer variability, which display how a same image may be classified as of appropriate quality in one occasion, but not on subsequent analysis or analysis by another operator. Consequently, it is not required for a DL algorithm to reach 100% accuracy in a subjective task, as it would merely signify perfect reproducibility of the judgement of a single operator at a single time. The cases with low degree of severity were the most likely to be misclassified, as well as the most frequent source of inter and intra-observer disagreement, as displayed in FIG. 5. That is, FIG. 5 shows an example visual representation of a comparison between manual and automated classification. The first row of FIG. 5 shows cases classified as “correct” both by manual assessment (both operators) and CCN_{QC}. The second row of FIG. 5 shows cases classified as “wrong” both by manual assessment (both operators) and CCN_{QC}; The third row of FIG. 5 shows cases classified as “wrong” by manual assessment (with disagreement between operators for 2-chamber) and as “correct” by CCN_{QC}. In FIG. 5: 0, correct; 1, wrong; Ch, chamber; GT, ground truth; R1, first operator; R2, second operator.

Second, the input data is highly unbalanced, as the natural consequence that radiographers aim to acquire good quality images, resulting in poor quality class to be significantly underrepresented. This is reflected by the significantly lower precision, recall and F1-scores for the identification of ‘wrong’ images compared to that of ‘correct’ ones. To reduce the bias of unbalanced data, the inventors used cross entropy loss, adaptive learning rate scheduler, and balanced accuracy, but such bias can never be fully controlled. Last, images to be considered of insufficient quality have a wide range of problems, from motion artefacts to off-axis planning of different types, making their grouping in one class difficult for the CNN. In particular, when evaluating 3-Chamber views, the quality of both the cardiac chamber and the aorta were considered, which might explain the lower performance compared to 2- and 4-Chamber views. On the other hand, separation in different classes would have resulted in further unbalance of the data, with insufficient numbers in each hypothetical poor-quality class. Therefore, it was decided to group them together. Moreover, training CNNQC as a binary classifier allows to select a desired threshold of error detection. In this study, the threshold that combined highest accuracy and highest sensitivity was used, but the user could shift it, should they wish to be less sensitive and more specific.

### Pre-Analysis QC Framework: Validation

The integration of the three steps of the framework yielded a safe, accurate and rapid system to select images of interest for analysis. The validation of the complete framework shows it is highly sensitive to detect erroneous images, with a 90% sensitivity of for 2-Chamber, 93% for 3-Chamber, and 94% for 4-Chamber acquisitions. This is achieved at the cost of a small proportion of good quality images being mistakenly labeled as erroneous, thus requiring clinician review. However, we believe this is a reasonable compromise as it ensures clinical safety within an automated process. Moreover, the process of review is fast in the falsely labelled data as it does only require a visual check from the clinician.

Of note, for the complete framework, we selected the CNN_{class} and CNN_{QC} that performed best in sequence, rather than the networks that performed best in the validation of the individual steps. This is important, as a sequential process can leverage individual strengths and weaknesses to obtain the best combined result.

As mentioned earlier, image selection is particularly important when multiple images of the same type are available, as it represents another time-consuming, but relatively simple task. Moreover, it is possible that a clinician doesn't recognize that an image was re-acquired later in the study and selects the first one, which could be of worse quality.

### Full Pipeline for Analysis of Cine CMR Images

Using the developed image-processing steps, the inventors have demonstrated a first pipeline for analysis of cardiac function from cine CMR that automates the complete process from scanner-to-report. The proposed pipeline does not only produce ventricular volumes and ejection fraction, but also to obtain a comprehensive set of systolic and diastolic function biomarkers, based on atrioventricular valve planar motion, ventricular filling and ejection dynamics and feature-tracking strain. This pipeline is characterized by a high degree of QC (one step in the new framework, two steps in the previously published one). Sequential QC steps focusing on different quality problems ensures a framework, where, if a poor-quality image slips through a first barrier, it will likely be flagged up in a later stage.

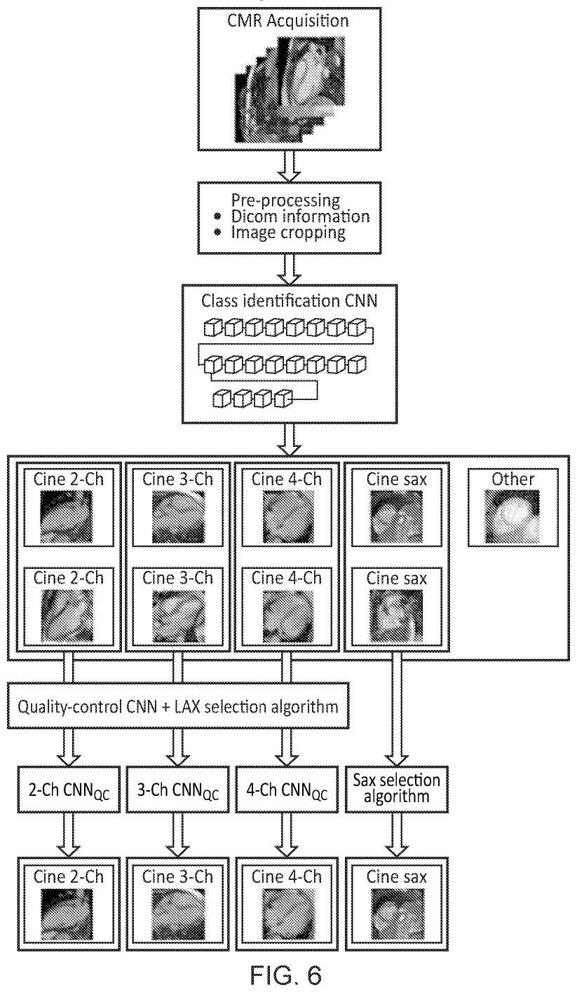

FIG. 6 is a diagrammatic representation of an example implementation of the pre-analysis QC framework or QC1 framework as described herein for automated identification and quality-controlled (QC) selection of cine images used for cardiac function analysis from routine clinical CMR exams. As seen in FIG. 6, the example implementation of the framework comprises of a first pre-processing step to exclude still images; two sequential convolutional neural networks (CNN), the first to classify images in standard cine views (2/3/4-chamber and short axis), the second to classify images according to image quality and orientation; a final algorithm to select one good image of each class. This construction allows for the framework, presented with a full CMR exam, to perform a quality-controlled selection of one good image for each conventional cine class, which is then used for analysis of cardiac function. In FIG. 6: Ch refers to chamber; CNN refers to convolutional neural network; LAX refers to long axis; SAX refers to short axis; QC refers to quality control.

We describe below some detailed results relating to the analysis step, in particular the segmentation step implementing the nnU-net algorithm.

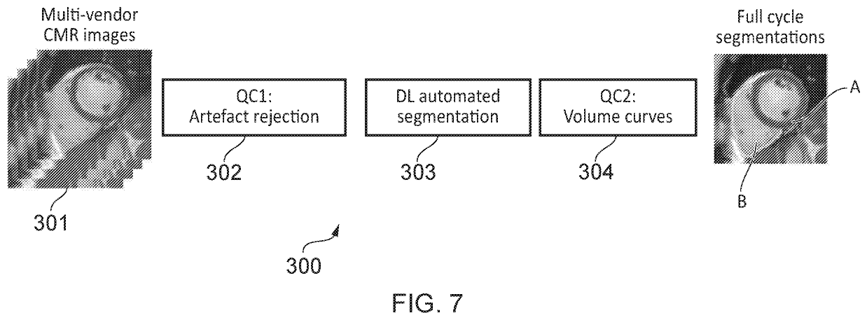

The flow chart shown in FIG. 7 is the same as the method 300 in FIG. 3 and FIG. 7 additionally shows the example images obtained using cine CMR in step 301 and the segmented output image data (step 302a) which has also been subjected to the post-analysis QC step 304. The segmentation in this case is labelled in FIG. 7 as A and B (see FIG. 7) over the cine CMR image sequence. The region marked A (circular in shape) represents the delineation of the cardiac cavity (inner) and myocardium (between inner and outer line) of the heart. The region marked B represents the delineation of the right ventricle of the heart.

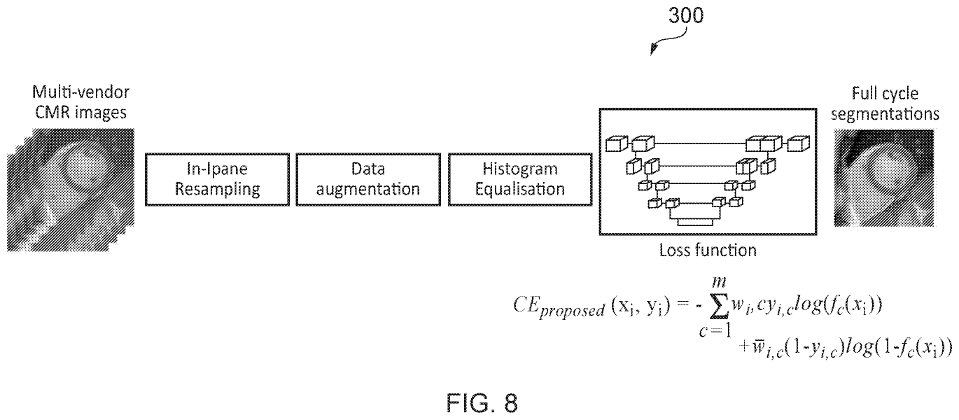

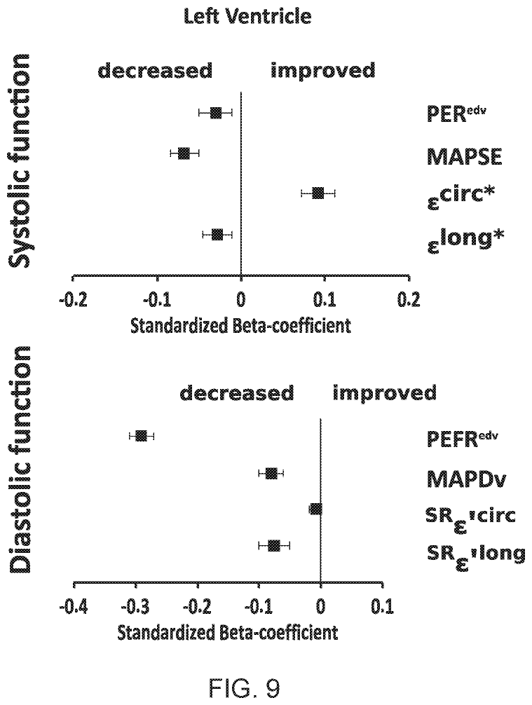

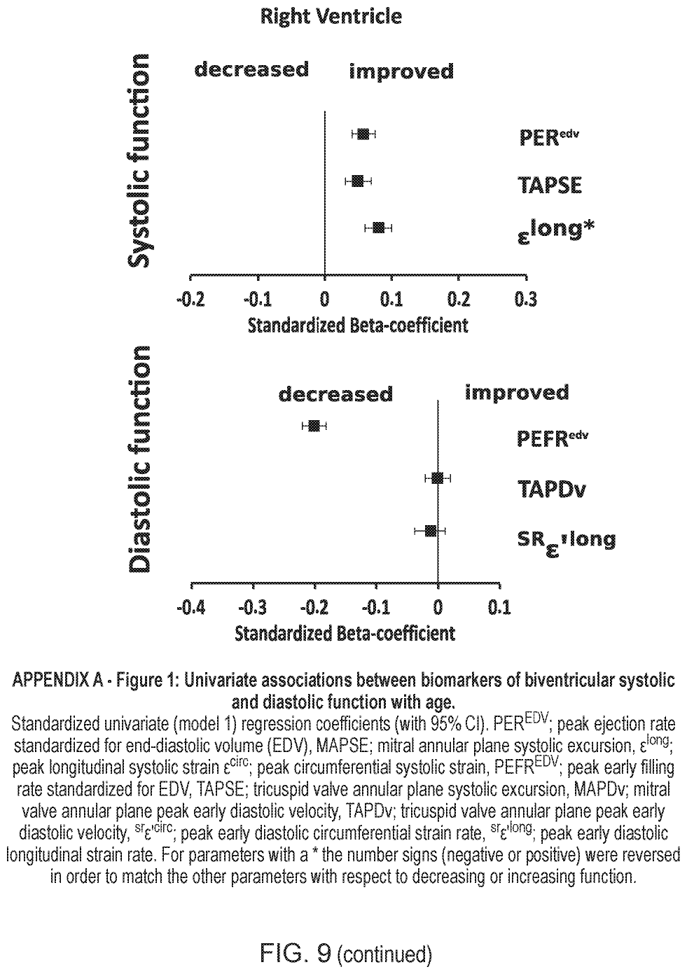

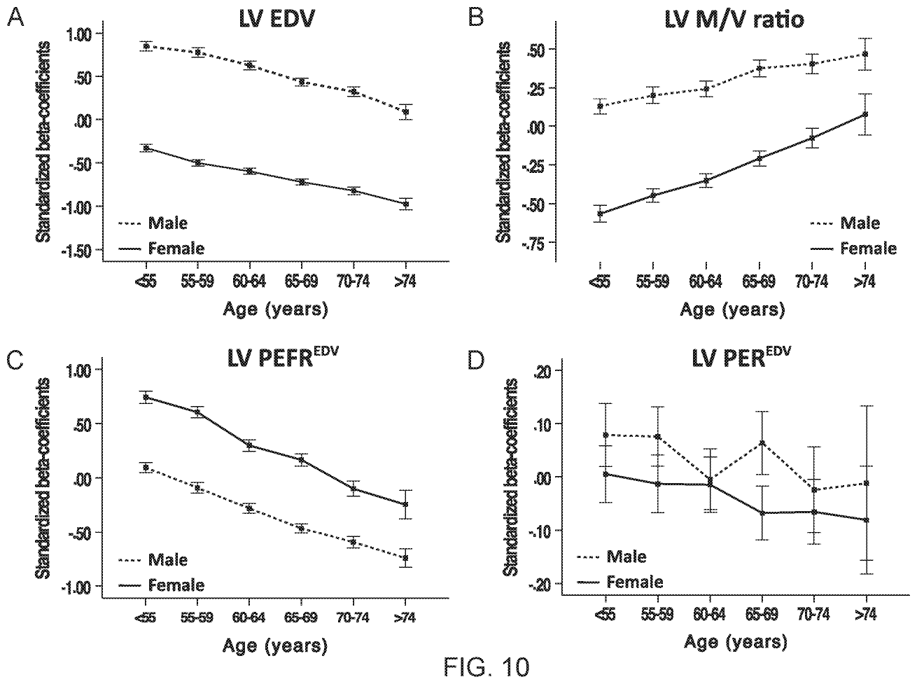

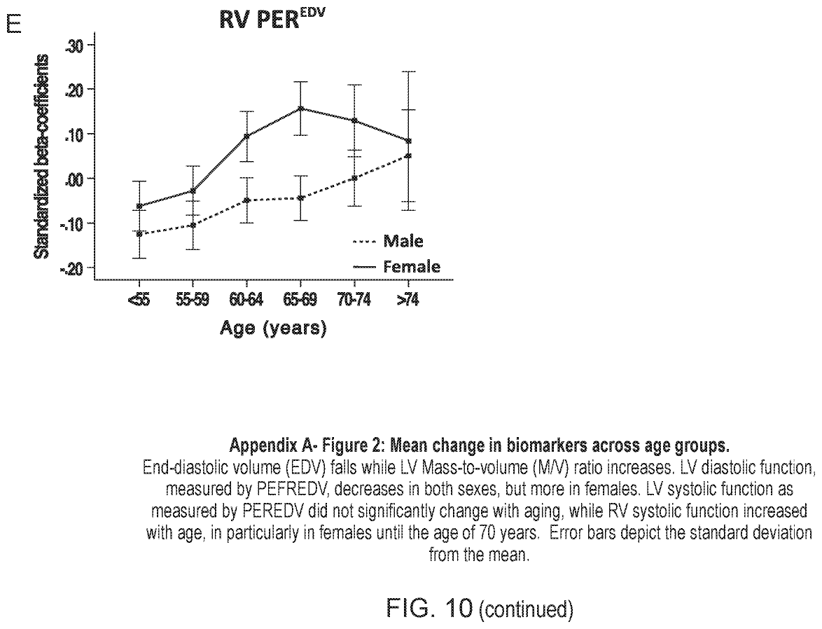

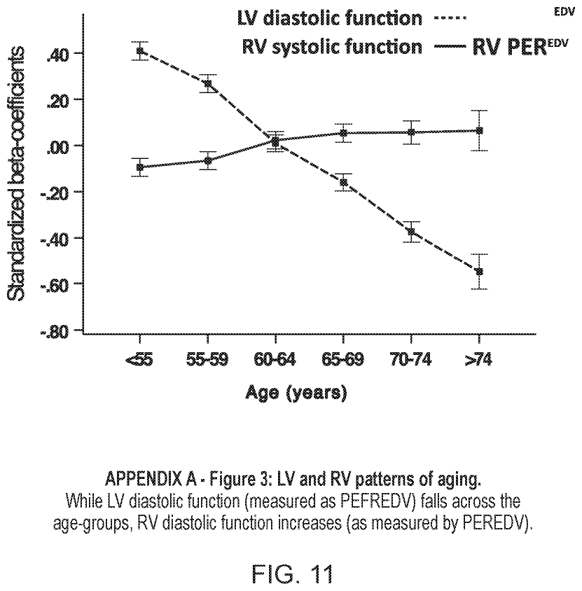

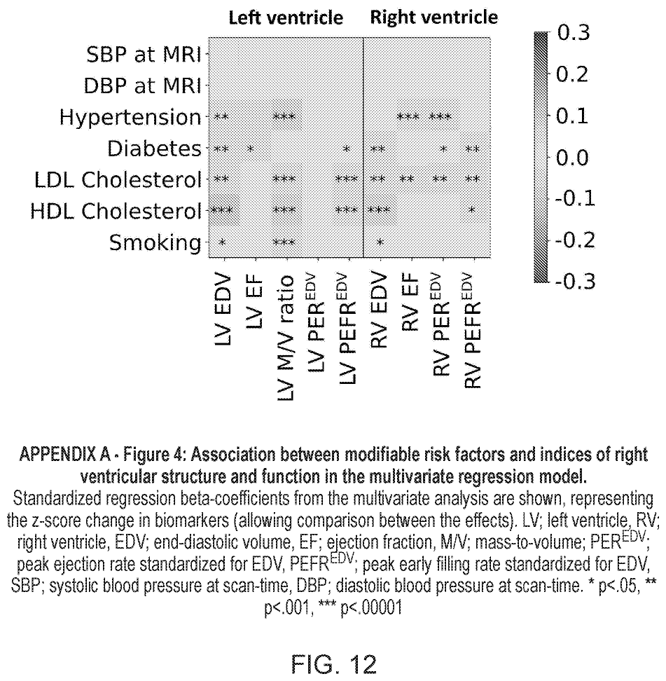

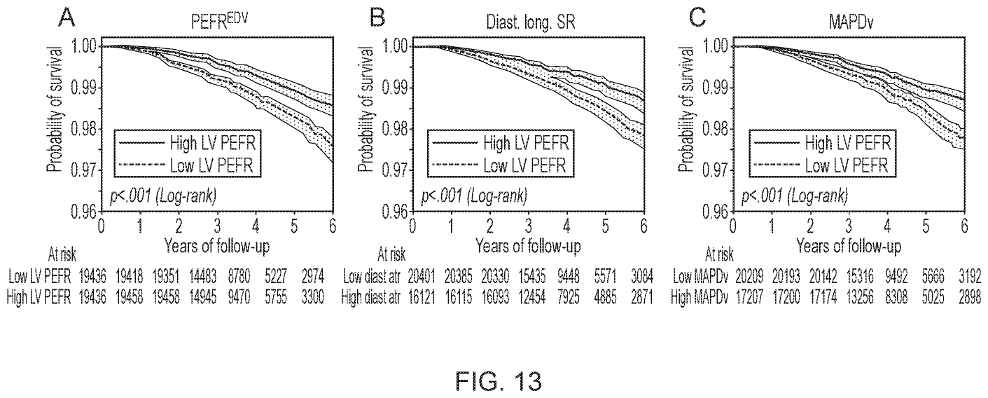

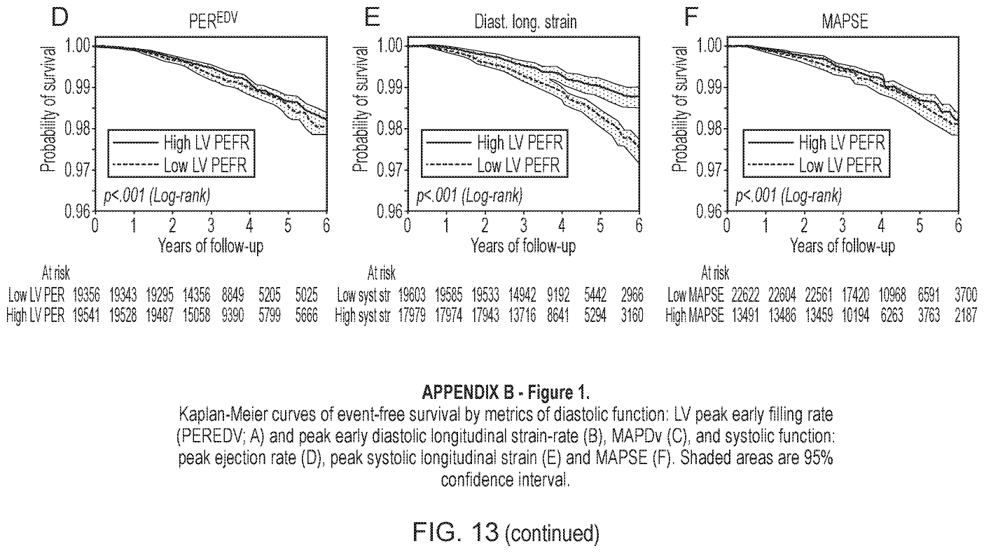

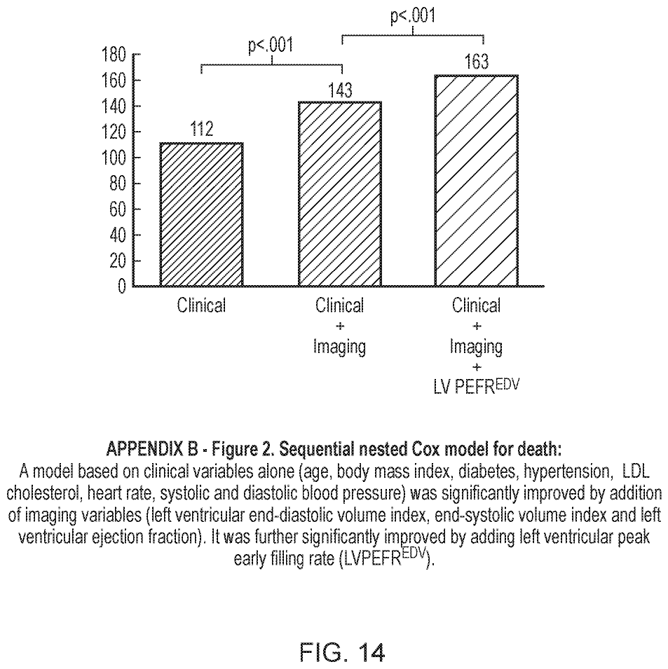

In a practical implementation of the above-described method in FIG. 3, in order to consider the variability between images from different input domains/clinical sites, an in-plane resampling (median voxel size of the cohort) and histogram equalization is first performed (see FIG. 8). A nnU-Net (‘no-new-Net’) architecture is used, as described in step 302a in FIG. 3, to segment the left and right ventricles and myocardium with a confidence-based weighted cross entropy loss that takes into account missing labels on the ground truth segmentation (see FIG. 8). The quality control steps QC1 and QC2 were used to detect erroneous outputs.

The AI analysis framework was validated in a large-scale database of cardiovascular disease patients containing data from the three most common CMR vendors (Philips, Siemens and General Electric) and two field strengths (1.5 and 3 T) from two academic institutions. The Dice coefficient/score, which measures the overlap between automatic and manual segmentations, and clinical measures was derived from segmentations (ventricular volume and mass).

TABLE 6
Dice coefficients/scores and clinical measures of ejection fraction
and ventricular volume and mass using the present method.
DICE SCORES

| | Database | | | | | | | | | |
|---|---|---|---|---|---|---|---|---|---|---|
| | UKBB | NHS | | | ACDC | M&Ms | | | | |
| | Siemens | Overall | Siemens | Philips | Siemens | Overall | Siemens | Philips | GE | Canon |
| Vendor | (n = 488) | (n = 331) | (n = 152) | (n = 179) | (n = 100) | (n = 271) | (n = 96) | (n = 125) | (n = 50) | (n = 50) |
| LV | 0.94 | 0.95 | 0.95 | 0.95 | 0.93 | 0.90 | 0.90 | 0.91 | 0.88 | 0.91 |
| | (0.04) | (0.08) | (0.09) | (0.06) | (0.06) | (0.07) | (0.07) | (0.06) | (0.09) | (0.06) |
| LV | 0.89 | 0.84 | 0.83 | 0.85 | 0.87 | 0.84 | 0.82 | 0.87 | 0.83 | 0.84 |
| myocardium | (0.03) | (0.10) | (0.12) | (0.08) | (0.03) | (0.05) | (0.04) | (0.04) | (0.06) | (0.04) |
| RV | 0.90 | 0.88 | 0.86 | 0.90 | 0.88 | 0.87 | 0.85 | 0.88 | 0.86 | 0.87 |
| | (0.06) | (0.16) | (0.17) | (0.15) | (0.07) | (0.07) | (0.09) | (0.06) | (0.06) | (0.08) |

CLINICAL MEASURES

| | LVEDV [mL] | LVESV [mL] | LVEF [%] | LVM [mL] | RVEDV [mL] | RVESV [mL] | RVEF [%] |
|---|---|---|---|---|---|---|---|
| Manual | 155.75 | 71.22 | 56.66 | 105.79 | 152.51 | 71.00 | 54.42 |
| | (52.68) | (48.06) | (12.54) | (40.62) | (44.73) | (33.36) | (10.97) |
| Proposed | 158.40 | 75.04 | 54.84 | 106.24 | 154.58 | 73.11 | 53.47 |
| | (53.57) | (48.96) | (12.14) | (37.90) | (44.26) | (32.08) | (10.77) |

Table 6 above shows preliminary evaluation of the method on a subset of 100 patients with ischemic cardiomyopathy, referred for CMR in the workup for cardiac resynchronisation therapy. In these patients with challenging imaging and low ejection fraction, Dice coefficients/scores of the segmentations (see Table 6) are similar to those obtained in earlier studies [8] in the highly controlled single vendor and single field strength UK-Biobank cohort. The table also shows good agreement between manual and automated ventricular volume and ejection fraction quantification. In Table 6, the parameters which have been evaluated using the implemented method comprise: left ventricular end-diastolic volume (LVEDV), left ventricular end systolic volume (LVESV), left ventricular ejection fraction (LVEF %), left ventricular myocardium (LVM), right ventricular end-diastolic volume (RVEDV), right ventricular end-systolic volume (RVESV) and right ventricular ejection fraction (RVEF %).

Using large-scale databases and data-processing techniques, the inventors show demonstrate the training of AI algorithms that can robustly deal with routine clinical data from multiple centres, CMR vendors and field strengths. This is a fundamental step for clinical translation of AI algorithms. Moreover, the method of the present invention yields a range of additional metrics of cardiac function (regional wall motion, filling and ejection rates and strain) at no extra computational cost.

The empirical results demonstrate that the full pipeline implementing the method of the present disclosure, including the pre-analysis QC step, is time-efficient and highly accurate, with a focus on high sensitivity, showing an improvement compared to a previously published work by the inventors [8].

In order to include a comprehensive overview of the development of method of the present disclosure, we have also included other empirical results obtained during development of the analysis step and post QC step of the present invention in Appendix A and Appendix B attached with this description.

Although this invention has been described in terms of certain embodiments, the embodiments can be combined to provide further embodiments. In addition, certain features shown in the context of one embodiment can be incorporated into other embodiments as well.

### REFERENCES

1. American College of Cardiology Foundation Task Force on Expert Consensus Documents, Hundley W G, Bluemke D A, Finn J P, Flamm S D, Fogel M A, et al. ACCF/ACR/AHA/NASCI/SCMR 2010 expert consensus document on cardiovascular magnetic resonance: a report of the American College of Cardiology Foundation Task Force on Expert Consensus Documents. J Am Coll Cardiol. 2010; 55(23): 2614-62.
2. Von Knobelsdorff-Brenkenhoff F, Schulz-Menger J. Role of cardiovascular magnetic resonance in the guidelines of the European Society of Cardiology. J Cardiovasc Magn Reson. 2016; 18: 6.
3. Leiner T, Bogaert J, Friedrich M G, Mohiaddin R, Muthurangu V, Myerson S, et al. SCMR Position Paper (2020) on clinical indications for cardiovascular magnetic resonance. J Cardiovasc Magn Reson. 2020;22(1):76.
4. Messroghli D R, Moon J C, Ferreira V M, Grosse-Wortmann L, He T, Kellman P, et al. Clinical recommendations for cardiovascular magnetic resonance mapping of T1, T2, T2* and extracellular volume: A consensus statement by the Society for Cardiovascular Magnetic Resonance (SCMR) endorsed by the European Association for Cardiovascular Imaging (EACVI). J Cardiovasc Magn Reson. 2017; 19(1): 75.
5. Schuster A, Hor K N, Kowallick J T, Beerbaum P, Kutty S. Cardiovascular magnetic resonance myocardial feature tracking: concepts and clinical applications. Circ Cardiovasc Imaging. 2016, (4):e004077.
6. Dyverfeldt P, Bissell M, Barker A J, Bolger A F, Carlhäll C J, Ebbers T, et al. 4D flow cardiovascular magnetic resonance consensus statement. Cardiovasc Magn Reson. 2015;17:72. doi: 10.1186/s12968-015-0174-5.
7. Bernard O, Lalande A, Zotti C, Cervenansky F, Yang X, Heng P-A, et al. Deep learning techniques for automatic MRI cardiac multi-structures segmentation and diagnosis: is the problem solved? IEEE Trans Med Imaging. 2018; 37:2514-25.
8. Ruijsink B, Puyol-Antón E, Oksuz I, Sinclair M, Bai W, Schnabel J A, et al. Fully Automated, Quality-Controlled Cardiac Analysis From CMR: Validation and Large-Scale Application to Characterize Cardiac Function. J ACC Cardiovasc Imaging. 2020 March; 13(3): 684-695.
9. Scannell C M, Veta M, Villa A D M, Sammut E C, Lee J, Breeuwer M, et al. Deep-Learning-Based Preprocessing for Quantitative Myocardial Perfusion MRI. J Magn Reson Imaging. 2020;51(6): 1689-1696.
10. Fahmy A S, Rausch J, Neisius U, Chan R H, Maron M S, Appelbaum E, et al. Automated cardiac MR scar quantification in hypertrophic cardiomyopathy using deep convolutional neural networks. JACC Cardiovasc Imaging. 2018; 11:1917-8.
11. Puyol-Antón E, Ruijsink B, Baumgartner C F, Masci P G, Sinclair M, Konukoglu E, et al. Automated quantification of myocardial tissue characteristics from native T 1 mapping using neural networks with uncertainty-based quality-control. J Cardiovasc Magn Reson. 2020 Aug 20;22(1):60.
12. Siegersma K R, Leiner T, Chew D P, Appelman Y, Hofstra L. Artificial intelligence in cardiovascular imaging: state of the art and implications for the imaging cardiologist. Neth Heart J. 2019; 27(9): 403-413.
13. Khamis H, Zurakhov G, Azar V, Raz A, Friedman Z, Adam D. Automatic apical view classification of echocardiograms using a discriminative learning dictionary. Med Image Anal. 2017;36:15-21.
14. Madani A, Arnaout R, Mofrad M, Arnaout R. Fast and accurate view classification of echocardiograms using deep learning. NPJ Digit Med. 2018; 1(6): 1-8.
15. Robinson R, Valindria V V, Bai W, Oktay O, Kainz B, Suzuki H, et al. Automated quality control in image segmentation: application to the UK biobank cardiovascular magnetic resonance imaging study. J Cardiovasc Magn Reson. (2019) 21:18.
16. Tarroni G, Oktay O, Bai W, Schuh A, Suzuki H, Passerat-Palmbach J, et al. Learning-based quality control for cardiac MR images. IEEE Trans Med Imaging. (2019) 38:1127-38.
17. Chen C, Qin C, Qiu H, Tarroni G, Duan J, Bai W, et al. Deep Learning for Cardiac Image Segmentation: A Review. Front Cardiovasc Med. 2020 5;7:25.
18. Sainath, Tara N., et al. “Convolutional, long short-term memory, fully connected deep neural networks.” 2015 IEEE international conference on acoustics, speech and signal processing (ICASSP). IEEE, 2015.
19. Komi S, Inoue Y, Hata H, Nakajima A, Miyatake H. Cardiovascular magnetic resonance evaluation of left ventricular peak filling rate using steady-state free precession and phase contrast sequences. Springerplus. 2016 Jul. 25;5(1): 1163. doi: 10.1186/s40064-016-2878-x. PMID: 27512622; PMCID: PMC4960092.
20. Mendoza D D, Codella N C, Wang Y, Prince M R, Sethi S, Manoushagian S J, Kawaji K, Min J K, LaBounty T M, Devereux R B, Weinsaft J W. Impact of diastolic dysfunction severity on global left ventricular volumetric filling—assessment by automated segmentation of routine cine cardiovascular magnetic resonance. J Cardiovasc Magn Reson. 2010 Jul. 31;12(1):46. doi: 10.1186/1532-429X-12-46. PMID: 20673372; PMCID: PMC2924850.
21. Seemann F, Pahlm U, Steding-Ehrenborg K, Ostenfeld E, Erlinge D, Dubois-Rande J L, Jensen S E, Atar D, Arheden H, Carlsson M, Heiberg E. Time-resolved tracking of the atrioventricular plane displacement in Cardiovascular Magnetic Resonance (CMR) images. BMC Med Imaging. 2017 Feb. 28;17(1):19. doi: 10.1186/s12880-017-0189-5. PMID: 28241751; PMCID: PMC5330030.
22. Campello, Víctor M., et al. “Multi-centre, multi-vendor and multi-disease cardiac segmentation: the M&Ms challenge. IEEE Transactions on Medical Imaging [under review].

### APPENDIX A: ANALYSIS OF HEALTHY CARDIAC AGEING

In this study, the inventors explored how aging impacts biventricular systolic and diastolic function in a large healthy population.

Methods: The inventors analysed biventricular systolic and diastolic function in 12,477 healthy individuals from the UK Biobank using a recently validated, fully-automated and quality-controlled framework for analysis of short- and long-axis cine cardiac magnetic resonance (AI-CMR^{QC}). The inventors obtained biventricular volumes, peak ventricular ejection rate and early filling rate, standardized for end-diastolic volume (PER^{EDV} and PEFR^{EDV}), tricuspid and mitral valve planar systolic excursion and diastolic velocity and peak systolic myocardial strain and diastolic strain-rate. Associations between age, cardiovascular riskfactors (CVrf) and biventricular systolic and diastolic function were analysed using standardized uni- and multivariate regression.

Results: Age was predominantly associated with a decline in left ventricular diastolic function (LV PEFR^{EDV} β=−0.29±0.02, p<0.0001). This decline was larger in females compared to males, corresponded to a fall in EDV and increase in LV mass-to-volume ratio and was exacerbated by CVrf. Contrary to the LV, RV systolic function increased

(RV PER^{EDV} β=0.06±0.01, p<0.0001). This increase coincided with the LV diastolic decline.

Conclusions: Cardiac aging is predominantly associated with a fall in LV diastolic function. Contrary to the LV, RV systolic function increased with age. This finding potentially suggests an adaptive mechanism of the RV to counteract some of the effects of LV stiffening.

### Introduction

The world's population is aging rapidly. The amount of people aged over 60 years has doubled from 1980 to 2017, and is expected to triple by 2030¹. With aging, the exposure to cardiovascular risk factors (CVrf) and incidence of heart diseases increases. Yet even in the absence of traditional CVrf or overt disease, cardiac function declines with age. This decline, even though asymptomatic, is not harmless; mild to moderate diastolic dysfunction in asymptomatic population dwellers has been associated with an increased hazard of mortality, with a hazard ratio of >8 compared to subjects with normal diastolic function².

Mapping the subtle changes in cardiac function in aging subjects is important to understand the risks of accelerated cardiac aging and target preventive interventions. Previous studies have investigated changes in cardiac volumes, obtained from cardiac MRI^{3,4}, and changes in diastolic function as measured by E/A ratio². However, to fully understand cardiac aging it is vital to obtain a comprehensive assessment of the simultaneous changes in biventricular systolic and diastolic function and morphology.

We have recently developed and validated an artificial intelligence (AI)-based quality-controlled (QC) framework for cine cardiac magnetic resonance (CMR) analysis (AI-CMR^{QC})⁵. Cine CMR scans allow accurate quantification of biventricular volumes and ejection fraction (EF). Moreover, an additional set of detailed biomarkers of systolic and diastolic cardiac function can be obtained from cine CMR images, such as myocardial strain, atrioventricular planar motion, and ventricular volume filling and ejection dynamics. AI-CMR^{QC} allows to obtain these parameters automatically from long- and short axis cine CMR and includes robust pre- and post-analysis QC algorithms that ensure image and segmentation quality, while flagging erroneous results to clinical users for review with a sensitivity of detecting errors of 95%.

In the current study, we utilise AI-CMR^{QC} to explore the impact of age and CVrf on biventricular function and morphology in a large cohort of healthy subjects. We obtained a description of biventricular volumes, systolic and diastolic function in a cohort of 12,477 healthy subjects selected from the UKBB, who are aging with or without CVrf, and assess the association between age and biventricular function, and the impact of CVrf.

### Methods

### Data Selection

At initiation of the study, CMR data was available for 50,000 subjects of the UK Biobank population study. From this cohort, we selected all healthy subjects, with and without known CVrf. We excluded all subjects with known cardiovascular disease, respiratory disease, haematological disease, renal disease, rheumatic disease, malignancies, symptoms of chest pain, respiratory symptoms or other diseases impacting the cardiovascular system, except for diabetes mellitus (DM), hypercholesterolemia and hypertension. A full table of exclusion criteria is included in Supplemental Table 1. We used the ICD-9 and ICD-10 codes, as well as self-reported detailed health questionnaires and medication history for the selection process. Subjects were classified as DM if they self-reported and/or had ICD codes and/or used medication associated with DM (excluding gestational diabetes), hypertension was defined as previous diagnosis or treatment for hypertension, and hypercholesterolemia as previous diagnosis or treatment for hypercholesterolemia. Subject characteristics obtained were; body measures (height, weight, body-mass index; BMI and body surface area; BSA), sex, smoker status (smoker was defined as a subject smoking or smoked daily for over 25 years in the previous 35 years) and LDL- and HDL-cholesterol levels. We also obtained the average heart rate during CMR (HR) and brachial systolic and diastolic blood pressure (SBP and DBP) measured during the CMR exam.

### CMR Processing

Our AI-CMR^{QC} pipeline analyses short axis and long axis (2-chamber and 4-chamber) cine CMR acquisitions. In short, our framework consists of a pre-analysis image QC step, a deep learning (DL) image segmentation algorithm that segments the LV and RV blood pool and myocardium over the full cardiac cycle, a quantification step that calculates LV, RV and myocardial volume and strain curves and their associated biomarkers, and lastly a post-analysis QC step. The pre-analysis QC step is a DL classifier that detects images that contain (breathing) motion and arrhythmia artefacts. The post-analysis QC step consists of a DL classification algorithm, which interrogates the shape of the ventricular volume, valvular excursion and strain curves, and a set of predefined rules based on common biophysical principles (such as similarity between left and right ventricular stroke volume and coverage of the segmentations between long- and short-axis images). For further details, see our previous publication 5.

The parameters obtained from the cine CMR scans were: left and right ventricular (LV and RV) volumes at end-diastole (EDV), end-systole (ESV), ejection fraction (EF), LV myocardial mass (LVmass) and mass-to-volume ratio (M/V ratio), as well as peak ventricular ejection and peak ventricular filling rates (which were divided by EDV to eliminate the dependency on ventricular size; PER^{EDV}, PEFR^{EDV})⁶, mitral and tricuspid valve annular plane systolic excursion (MAPSE and TAPSE) and early diastolic velocities (MAPDv, TAPDv)^{7,8}, RV and LV global longitudinal and LV global circumferential peak systolic myocardial strain (ε^{long} and ε^{circ}) and early diastolic strain rates (^{sr}e′^{circ} and ^{sr}e′^{long}).

### Statistical Analysis

Data-analysis was performed using SPSS Statistics version 23 (IBM, USA). Data is expressed as mean # standard deviation (SD). Missing values and outliers, defined a priori as values more than three interquartile ranges below the first quartile or above the third quartile, were excluded from further analysis. We considered ventricular volumes and mass as absolute measures and as indexed to BMI. Independent associations between increasing age and all parameters were performed using univariate linear regression at first (model 1), and after multivariate adjustment for sex, height, weight, HR at MRI, systolic and diastolic blood pressure, DM, hypertension, hypercholesterolemia, LDL and HDL cholesterol levels and smoking (model 2). Non-Gaussian parameters were log-transformed. All variables in the regression models were standardized by computing the z-score for individual data points. This allowed us to compare the coefficients of the covariates within one regression model among each other.

### Biomarker Selection

Several biomarkers of ventricular diastolic function can be obtained from cine CMR, but no evidence exists on which measurement is most sensitive to change in diastolic function. AI-CMR^{QC} yields a range of these biomarkers, depicting different aspects of the ventricular contraction (PEFR^{EDV} reflects ventricular volume dynamics, sre'circ myocardial kinetics, etc.). For clarity, we decided, a-priori, to select a single measure of diastolic and systolic function to describe the impact of age on biventricular function. To do so, we selected the parameter that most sensitively represented the change in diastolic function during aging (i.e. had the highest standardized beta-coefficient in a univariate linear regression). For systolic function we used the measure that represented the same aspect of ventricular contraction to the selected diastolic biomarker, in order to equally compare changes in diastolic and systolic function. The analysis of the remaining parameters is presented in the supplemental materials.

### Results

### Subject Characteristics

After applying the exclusion criteria, 12,493 healthy subjects (48% female) remained for analysis. See the subject characteristics in Table 1. The mean age of the cohort was 62.7±7.5 years, mean weight was 76.2±14.5 kilograms, mean height was 170±9 cm and mean body-mass index (BMI) was 26±4. 2,629 subjects (21%) were classified as having hypertension, 401 (3%) had DM and 1,737 (14%) had hypercholesterolemia. Mean cholesterol level in the full study cohort was 5.76±1.0 mmol/L, mean HDL-cholesterol was 1.49±0.4 mmol/L. 2,983 (25%) of subjects were classified as smokers. CVrf were more common in men than women.

Biomarker of diastolic aging

FIG. 1 shows the beta-coefficients obtained from univariate analysis of the individual parameters of LV and RV diastolic function. PEFR^{EDV} exhibited the strongest association with age, both in the total cohort as well as stratified for sex. This parameter and its equivalent of systolic function, PER^{EDV}, were therefore chosen for further analysis of systolic and diastolic function. The other parameters of LV function showed similar effects (decrease or increase) to the ones selected, except for LV peak systolic ε^{circ}, which was associated with increased, instead of decreased systolic function. For the RV, no association with age was seen with the diastolic function parameters MAPDv and ^{sr}e′^{long}.

### Morphological Changes

Age was associated with a fall in EDV in both ventricles (LV β=−0.18±0.02, p<0.0001 and RV β=−0.17±0.02, p<0.0001). The fall in EDV was larger in females compared to males (see FIG. 2A). LVmass also decreased with age (β=−0.07±0.02, p<0.0001), but due to the smaller fall in mass compared to volume, the M/V ratio increased (β=+0.16±0.02, p<0.0001). This increase was more pronounced in females compared to males (see FIG. 2B). All these changes remained significant after multivariate adjustment (see Table 2).

### Diastolic and Systolic Function

LV diastolic function declined with age (LV PEFR^{EDV} β=−0.29±0.02, p<0.0001). This fall in diastolic function was more pronounced in females compared to males (see FIG. 2C). In the RV, diastolic function also declined (RV PEFR^{EDV} β=−0.20±0.02, p<0.0001), but this decline was lower compared to the LV (p<0.0001), with again a faster decline in females compared to males (p<0.0001).

LV systolic function as measured by LV PER^{EDV} decreased with age (β=−0.03±0.02, p<0.001), but the decrease in systolic function was relatively less pronounced compared to the LV diastolic decline, see Table 1 and FIG. 2D. The change in LV PER^{EDV} was not significantly different in males compared to females. Contrary to the LV, RV systolic function increased with age (RV PER^{EDV} β=+0.06±0.01, p<0.0001, see FIG. 2E). This increase coincided with the stiffening of the LV, measured by the falling LV diastolic function, see FIG. 3.

All associations remained significant after multivariate adjustment. The other biomarkers of systolic and diastolic LV and RV function showed patterns similar to the data presented here. Except for RV diastolic function, the remaining parameters suggest no change in diastolic function with aging (see FIG. 1 and supplemental Table 1).

Subjects with low diastolic function, as defined as the lowest tertile of LV PFR^{EDV}, had significantly higher RV PER^{EDV} and increased RV peak ε^{long} compared to subjects with an LV PFR^{EDV} in the highest tertile (RV PER^{EDV} z-score; 0.40±1.02 vs. −0.27±0.94. p<0.0001, RV peak ε^{long} z-score; −0.09±0.79 vs. 0.15±1.49, p<0.0001).

### Impact of CVrf

The outcome of the multivariate regression coefficients for CVrf with regard to biventricular function is shown in FIG. 4. The exact standardized beta-coefficients for the different CVrf's can be found in Supplemental Table 3 and 4.

In the LV, DM (β=−0.02±0.01, p=0.01) and LDL cholesterol levels (β=−0.05±0.03, p<0.001) were associated with a lower diastolic function as measured by PEFR^{EDV}. On the contrary, HDL cholesterol levels were associated with a preserved diastolic function (β=+0.06±0.02, p<0.0001). Subjects in the higher tertile had a 10% better PEFR^{EDV} compared to those with an HDL cholesterol levels in the lowest tertile (2.22±0.59 vs 1.98±0.54, p<0.0001). SBP and DBP at time of CMR, as well as being classified as having hypertension or smoking status did not affect LV PEFR^{EDV}.

A similar pattern was observed for RV diastolic function, where DM (β=−0.02±0.02, p=0.007) and LDL cholesterol levels (β=−0.03±0.02, p=0.008) were associated with a decline in RV PEFR^{EDV}, while HDL cholesterol again was associated with better-maintained diastolic function (β=+0.03±0.02, p=0.01). SBP, DBP, hypertension and smoking status again did not impact RV diastolic function.

The impact of CVrf on LV diastolic function was similar to that seen for LV EDV (see Table 3).

With regard to systolic function, LDL Cholesterol (β=+0.03±0.02, p<0.001) and hypertension (β=+0.06±0.02, p<0.0001) were associated with an increase in RV PER^{EDV}, while diabetes was associated with a decrease (β=−0.02±0.02, p=0.04). For the LV, there was a trend towards significant association between hypertension and increased systolic function (LV PER^{EDV} β=+0.2±0.1, p=0.05).

### Discussion

In this study we investigated the association between age and biventricular systolic and diastolic cardiac function. Previous CMR-based population studies, performed in the MESA⁴ and UKBB populations³, have described how ventricular volumes change with aging, while an echo-based study described LV diastolic function, measured by mitral valve inflow patterns in a general population². However, these studies do not paint a complete picture of cardiac aging; changes in ventricular volumes do not linearly reflect changes in function and changes in one ventricle irrefutably impact the other. To the best of our knowledge, our study is the first population study to investigate the impact of age on biventricular morphology, systolic and diastolic function simultaneously. To do so, we utilised AI-CMR^{QC}, our recently validated, state-of-the-art QC pipeline for automated analysis of full cardiac cycle long and short axis cine CMR⁵. Our study provides several key insights: 1) cardiac aging is predominantly associated with an LV diastolic function decline, 2) in the RV, aging is associated with an increase in systolic function. This increase coincides with the LV diastolic decline and could potentially suggest a compensatory mechanism to counteract some of the deterioration of LV diastolic function during aging, and finally 3) diabetes and cholesterol levels impact diastolic aging, but afterload (blood pressure and hypertension) seems to have less of an impact on its development.

With regard to morphology, we showed that increasing age is associated with a fall in both LV and RV volumes. This fall was larger in females compared to males. LV myocardial mass also decreased with age, but this decrease was smaller than the fall in EDV, resulting in an increase in M/V ratio. The M/V ratio increase was larger in females compared to males (see FIG. 2B). These findings are similar to observations in earlier population studies investigating cardiac volume changes with age using CMR⁹⁻¹¹ and echocardiography^{12,13}.

The additional analysis of biventricular diastolic and systolic function in our study allows us to further describe the processes of cardiac aging. We showed that the fall in LV volumes with age reflects a decline in LV diastolic function. Notably, the diastolic decline associated with aging was more pronounced in women, even after adjusting for CVrf. This is also in keeping with the larger M/V ratio found in this group. LV EF did not change with aging. Previous studies have reported similar results⁹, but as EF is impacted by the falling EDV, its value does not reflect actual systolic function. Our work showed that LV systolic function is in fact decreasing with age. Interestingly, ε^{circ} increased with age contrary to the other parameters of LV systolic function, see FIG. 1. This suggests an adaption from a longitudinal to more circumferential contraction pattern. Similar observations have been made in patients with subclinical systolic dysfunction after receiving cardiotoxic chemotherapy¹⁴ and likely reflect a compensatory mechanism of LV mechanics in early/mild systolic dysfunction.

While both LV systolic and diastolic function were affected by age, our data suggests that the effect on diastolic function dominates over the changes in systolic function: The magnitude of changes in PEFR with age are much larger than the ones observed for PER, as can be appreciated from the reported standardized coefficients in Table 2. This finding is in keeping with the earlier echo-study, which showed a high prevalence of diastolic dysfunction in asymptomatic subjects².

Contrary to the LV, we found that RV systolic function increased with age (see FIG. 1). This increase coincided with the LV's fall in diastolic function, as shown in FIG. 3 and the higher RV systolic parameters in subjects with low vs preserved diastolic function (depicted by the lowest vs. higher tertile of LV PFR^{EDV}). In females, the RV's systolic response was larger compared to males, in particular up to the age of 70 years (see Table 3 and FIG. 2E). This is also the group that exhibited the largest fall in LV diastolic function (FIG. 2C). These findings are noteworthy. They seem to suggest that the RV's increase in systolic function is associated with LV diastolic stiffening. Several previous studies suggest that RV systolic function is an important independent predictor of outcome in LV disease¹⁵⁻¹⁷. In a recent work aimed at understanding the mechanism behind this beneficial effect, we have shown that RV systolic function plays a vital role in regulation of LV filling during exercise, helping to minimize the total energetic cost of cardiac contraction¹⁸. In this light, the RV's increase in systolic function with aging could potentially suggest a compensatory response of the RV to alleviate some of the effects of LV ventricular stiffening, by supporting blood flow towards the left heart. These changes could explain the higher prevalence of heart failure with preserved ejection fraction (HFpEF) observed in women, in particularly after the sixth decade of age¹⁹. Whether the RV indeed plays a compensatory role in subjects with LV diastolic dysfunction² and impacts outcomes in patients with HFpEF, remains to be seen in future studies.

### CVrf and Aging

We also explored the impact of traditional CVrf on cardiac aging. Our results show that diastolic function was most affected by CVrf, see FIG. 4 and Supplemental Table 3. Diabetes and high LDL cholesterol levels were associated with accelerated diastolic functional decline. Interestingly, we found that being diagnosed with hypertension, as well as SBP and DBP at the time of CMR, did not significantly impact the diastolic function. These findings suggest that at least part of the process of cardiac aging is mediated through a direct effect of CVrf on myocardial composition and microvasculature itself^{20,21}. However, additional investigations of the impact of vascular stiffness on biventricular function are needed to further understand these observations.

Our study suggests that HDL cholesterol levels have a beneficial impact on cardiac aging. High HDL cholesterol levels were associated with better diastolic function. HDL cholesterol is known to protect against cardiovascular events²². Its beneficial effects stem from reverse cholesterol transport, anti-inflammatory and anti-oxidant mechanisms, that act on the epicardial coronary vasculature, but also the myocardium directly^{23,24}. The beneficial impact of HDL on cardiac volumes was previously suggested in the MESA cohort⁴. Its relation to diastolic aging has not previously been described, but is in keeping with findings observed in patients with cardiac disease^{25,26}. This evidence supports the inclusion of HDL cholesterol levels in risk prediction models in healthy subjects aging with CVrf.

### CMR Biomarkers of Aging

PER, PEFR, myocardial strain, and atrio-ventricular valve dynamics are established and sensitive measures of systolic and diastolic function, making them excellent tools to investigate changes in cardiac function in a healthy aging population. However, obtaining these measures manually is labour intensive. This has limited the size of previous studies. Despite this, our findings are largely in keeping with studies investigating the individual parameters PER^{EDV}, PEFR^{EDV}, MAPSE and myocardial strain in smaller cohorts of subjects with and without CVrf^{6,7,27,28}.

Our AI-CMR^{QC} method yields the full range of systolic and diastolic parameters discussed above. We showed that PEFR^{EDV} was the biomarker that most sensitively detects the changing diastolic function with aging. The rationale behind correction of PEFR and PER for EDV was to eliminate the impact of ventricular size on the measurements. Previous studies have reported a similar approach⁶. Analysis of the data using non-adjusted measures of PER and PEFR did not lead to changes in the observed behaviour during aging. Finally, the auxiliary parameters of systolic and diastolic function obtained in this study showed similar trends to the ones described for PEFR^{EDV} and PER^{EDV}, and their analysis can be reviewed in the supplemental data.

### Limitations

This study has several limitations. Firstly, this is a cross-sectional study that aims to infer longitudinal patterns using data points obtained at a single time point from a large group of subjects of different ages. Longitudinal data will be necessary to confirm our findings. The UKBB cohort will include follow-up imaging visits and the data of these visits will become available in the coming years. Secondly, the population included in the UKBB is sampled at random for invitation to undergo a CMR scan. However, the associated visit to an imaging site might introduce bias and select only relatively healthy aging subjects. We can therefore not exclude the existence of this selection bias nor the presence of subclinical disease in some of the healthy subjects. Thirdly, the effects observed for CVrf are merely associations. Their causal relationships cannot be assessed based on our data. Lastly, we cannot 100% exclude errors in the automated analysis with AI-CMR^{QC}. However in our previous validation we showed that our method was accurate and the QC steps detect 95% of erroneous outputs. It is therefore unlikely that these errors significantly affected our analysis. Additionally, the UKBB population consists mostly of subjects of European ancestry. Lastly, fluid retention and changes in preload during aging could influence the trends observed in RV function. We used standardized metrics to limit the impact of these changes on our measures, but could not measure and correct completely for changes in fluid status in subjects over the different age groups.

### Conclusion

We studied biventricular cardiac aging in a large population of healthy subjects using an automated, quality-controlled AI-based method for comprehensive analysis of ventricular volumes, systolic and diastolic function from cine CMR. Our study reveals that age was associated with a decline in LV diastolic function. It further shows that RV systolic function increased with age, and the observed trends seem to suggest that this increase coincides with LV diastolic decline. This could suggest that the RV plays a role in balancing the impact of diastolic dysfunction during cardiac aging. Finally, we show that HDL cholesterol was associated with better preservation of cardiac function with age, while increased afterload did not seem to have an important impact on cardiac aging.

### REFERENCES

1. United Nations Department of Economic and Social Affairs Population Division. World Population Ageing 2017—Highlights. 2017. p. 1-124.
2. Redfield M M, Jacobsen S J, Burnett J C, Mahoney D W, Bailey K R, Rodeheffer R J. Burden of Systolic and Diastolic Ventricular Dysfunction in the Community. Jama 2003; 289:194.
3. Cetin I, Raisi-Estabragh Z, Petersen S E, Napel S, Piechnik S K, Neubauer S, Gonzalez Ballester M A, Camara O, Lekadir K. Radiomics Signatures of Cardiovascular Risk Factors in Cardiac MRI: Results From the UK Biobank. Front Cardiovasc Med 2020; 7:1-12.
4. Heckbert S R, Post W, Pearson G D N, Arnett D K, Gomes A S, Jerosch-Herold M, Hundley W G, Lima J A, Bluemke D A. Traditional Cardiovascular Risk Factors in Relation to Left Ventricular Mass, Volume, and Systolic Function by Cardiac Magnetic Resonance Imaging. The Multiethnic Study of Atherosclerosis. J Am Coll Cardiol Elsevier; 2006;48:2285-2292.
5. Ruijsink B, Puyol-Antón E, Oksuz I, Sinclair M, Bai W, Schnabel J A, Razavi R, King A P. Fully Automated, Quality-Controlled Cardiac Analysis From CMR: Validation and Large-Scale Application to Characterize Cardiac Function. JACC Cardiovasc Imaging Elsevier Inc.; 2020; 13:684-695.
6. Kawel-Boehm N, Maceira A, Valsangiacomo-Buechel E R, Vogel-Claussen J, Turkbey E B, Williams R, Plein S, Tee M, Eng J, Bluemke D A. Normal values for cardiovascular magnetic resonance in adults and children. J Cardiovasc Magn Reson BioMed Central; 2015; 17:29.
7. Grue J F, Storve S, Dalen H, Salvesen Ø, Mjølstad O C, Samstad S O, Torp H, Haugen B O. Automatic Measurements of Mitral Annular Plane Systolic Excursion and Velocities to Detect Left Ventricular Dysfunction. Ultrasound Med Biol Elsevier Inc.; 2018;44:168-176.
8. Guetter C, Thavendiranathan P, Jolly M-P, Lu X, Xue H, Simonetti O P. Mitral valve annular velocity measurements derived from cine MRI: validation against Doppler echocardiography. J Cardiovasc Magn Reson BioMed Central Ltd; 2012; 14:W19.
9. Petersen S E, Aung N, Sanghvi M M, Zemrak F, Fung K, Paiva J M, Francis J M, Khanji M Y, Lukaschuk E, Lee A M, Carapella V, Kim Y J, Leeson P, Piechnik S K, Neubauer S. Reference ranges for cardiac structure and function using cardiovascular magnetic resonance (CMR) in Caucasians from the UK Biobank population cohort. J Cardiovasc Magn Reson BioMed Central; 2017; 19:18.
10. Cheng S, Fernandes V R S, Bluemke D A, McClelland R L, Kronmal R A, Lima J A C. Age-related left ventricular remodeling and associated risk for cardiovascular outcomes the multi-ethnic study of atherosclerosis. Circ Cardiovasc Imaging 2009;2:191-198.
11. Eng J, McClelland R, Gomes A, Hundley W, Cheng S, Wu C, Carr J, Shea S, Bluemke D, Lima J. Adverse Left Ventricular Remodeling and Age Assessed with Cardiac MR Imaging: The Multi-Ethnic Study of Atherosclerosis. Radiology Radiology; 2016; 278:714-722.
12. Hung C L, Gonçalves A, Shah A M, Cheng S, Kitzman D, Solomon SD. Age- and Sex-Related Influences on Left Ventricular Mechanics in Elderly Individuals Free of Prevalent Heart Failure: The ARIC Study (Atherosclerosis Risk in Communities). Circ Cardiovasc Imaging 2017; 10:1-9.
13. Cheng S, Xanthakis V, Sullivan L M, Lieb W, Massaro J, Aragam J, Benjamin E J, Vasan R S. Correlates of echocardiographic indices of cardiac remodeling over the adult life course: Longitudinal observations from the framingham heart study. Circulation 2010; 122:570-578.
14. Thavendiranathan P, Poulin F, Lim K-D, Plana J C, Woo A, Marwick T H. Use of myocardial strain imaging by echocardiography for the early detection of cardiotoxicity in patients during and after cancer chemotherapy: a systematic review. J Am Coll Cardiol Elsevier; 2014;63:2751-2768.
15. Everdingen W M van, Walmsley J, Cramer M J, Hagen I van, Boeck B W L De, Meine M, Delhaas T, Doevendans P A, Prinzen F W, Lumens J, Leenders G E. Echocardiographic prediction of cardiac resynchronization therapy response requires analysis of both mechanical dyssynchrony and right ventricular function. J Am Soc Echocardiogr 2017;30:1012-1020.
16. Kjaergaard J, Akkan D, Iversen K K, Køber L, Torp-Pedersen C, Hassager C. Right ventricular dysfunction as an independent predictor of short- and long-term mortality in patients with heart failure. Eur J Heart Fail 2007;9:610-616.
17. Meyer P, Filippatos G S, Ahmed M I, Iskandrian A E, Bittner V, Perry G J, White M, Aban I B, Mujib M, Dell'Italia L J, Ahmed A. Effects of right ventricular ejection fraction on outcomes in chronic systolic heart failure. Circulation 2010; 121:252-258.
18. Ruijsink B, Velasco Forte M N, Duong P, Asner L, Pushparajah K, Frigiola A, Nordsletten D, Razavi R. Synergy in the heart: RV systolic function plays a key role in optimizing LV performance during exercise. Am J Physiol Heart Circ Physiol 2020; 319:H642-H650.
19. Beale A L, Nanayakkara S, Segan L, Mariani J A, Maeder M T, Empel V van, Vizi D, Evans S, Lam C S P, Kaye D M. Sex Differences in Heart Failure With Preserved Ejection Fraction Pathophysiology: A Detailed Invasive Hemodynamic and Echocardiographic Analysis. JACC Hear Fail 2019;7:239-249.
20. Jia G, Hill M A, Sowers J R. Diabetic cardiomyopathy: An update of mechanisms contributing to this clinical entity. Circ Res 2018; 122:624-638.
21. Borén J, John Chapman M, Krauss R M, Packard C J, Bentzon J F, Binder C J, Daemen M J, Demer L L, Hegele R A, Nicholls S J, Nordestgaard B G, Watts G F, Bruckert E, Fazio S, Ference B A, Graham I, Horton J D, Landmesser U, Laufs U, Masana L, Pasterkamp G, Raal F J, Ray K K, Schunkert H, Taskinen M R, Sluis B van de, Wiklund O, Tokgozoglu L, Catapano A L, Ginsberg H N. Low-density lipoproteins cause atherosclerotic cardiovascular disease: Pathophysiological, genetic, and therapeutic insights: A consensus statement from the European Atherosclerosis Society Consensus Panel. Eur Heart J 2020;41:2313-2330.
22. Cooney M T, Dudina A, Bacquer D De, Wilhelmsen L, Sans S, Menotti A, Backer G De, Jousilahti P, Keil U, Thomsen T, Whincup P, Graham I M. HDL cholesterol protects against cardiovascular disease in both genders, at all ages and at all levels of risk. Atherosclerosis Ireland; 2009; 206:611-616.
23. deGoma E M, deGoma R L, Rader D J. Beyond High-Density Lipoprotein Cholesterol Levels. Evaluating High-Density Lipoprotein Function as Influenced by Novel Therapeutic Approaches. J. Am. Coll. Cardiol. Journal of the American College of Cardiology; 2008. p. 2199-2211.
24. Amin R, Muthuramu I, Aboumsallem J P, Mishra M, Jacobs F, Geest B De. Selective HDL-raising human apo A-I gene therapy counteracts cardiac hypertrophy, reduces myocardial fibrosis, and improves cardiac function in mice with chronic pressure overload. Int J Mol Sci 2017; 18:1-14.
25. Sun L, Liu X, Li W, Jia D. HDL-C to hsCRP ratio is associated with left ventricular diastolic function in absence of significant coronary atherosclerosis. Lipids Health Dis 2019; 18:1-8.
26. Horio T, Miyazato J, Kamide K, Takiuchi S, Kawano Y. Influence of Low High-Density Lipoprotein Cholesterol on Left Ventricular Hypertrophy and Diastolic Function in Essential Hypertension. Am J Hypertens Elsevier Inc.; 2003;16:938-944.
27. Feng W, Nagaraj H, Gupta H, Lloyd S G, Aban I, Perry G J, Calhoun D A, Dell'Italia L J, Denney T S. A dual propagation contours technique for semi-automated assessment of systolic and diastolic cardiac function by CMR. J Cardiovasc Magn Reson 2009; 11.
28. Andre F, Steen H, Matheis P, Westkott M, Breuninger K, Sander Y, Kammerer R, Galuschky C, Giannitsis E, Korosoglou G, Katus H A, Buss S J. Age- and gender-related normal left ventricular deformation assessed by cardiovascular magnetic resonance feature tracking. J Cardiovasc Magn Reson 2015; 17:1-14.

TABLE 1
Patient Characteristics

| | Total | | Male | | Female | | |
|---|---|---|---|---|---|---|---|
| | Cohort | | Participants | | Participants | | |
| Characteristics | (n = 12,493) | | (n = 6,493) | | (n = 6,000) | | P-value |
| Age, years (n = 12,493) | 62.7 ± 7.5 | | 63.0 ± 7.6 | | 62.4 ± 7.3 | | <0.0001 |
| Height, cm (n = 12,493) | 170.1 ± 9.2 | | 176.4 ± 6.5 | | 163.9 ± 6.1 | | <0.0001 |
| Weight, kg (n = 12,493) | 76.2 ± 14.5 | | 83.7 ± 12.5 | | 68.0 ± 11.9 | | <0.0001 |
| Body Mass Index (n = 12,493) | 26.1 ± 4.0 | | 26.8 ± 3.60 | | 25.4 ± 4.2 | | <0.0001 |
| Systolic BP, mmHg (n = 12,468) | 136.8 ± 22.5 | | 136.8 ± 22.6 | | 136.7 ± 22.3 | | <0.0001 |
| Diastolic BP, mmHg (n = 12,468) | 69.0 ± 12.3 | | 69.0 ± 12.6 | | 69.0 ± 12.2 | | <0.0001 |
| Heart rate, bpm (n = 12,468) | 59.7 ± 10.0 | | 58.9 ± 10.1 | | 60.7 ± 9.84 | | <0.0001 |
| Smoker, % (n = 12,493) | 2,903 | (23) | 1,691 | (26.0) | 1,212 | (20.0) | <0.0001 |
| Hypertension, % (n = 12,493) | 2,629 | (21.0) | 1,633 | (33.6) | 996 | (16.6) | <0.0001 |
| Diabetes mellitus, % (n = 12,493) | 401 | (3.2) | 119 | (1.9) | 282 | (4.3) | <0.0001 |
| Cholesterol, mmol/L (n = 12,493) | 5.76 | (1.0) | 5.69 | (1.0) | 5.83 | (1.1) | <0.0001 |

| | | | | | |
|---|---|---|---|---|---|
| HDL Cholesterol, mmol/L (10,880) | 1.49 | (0.4) | 1.33 ± 0.31 | 1.66 ± 0.37 | <0.0001 |

| | | | | |
|---|---|---|---|---|
| LV EDV, mL (n = 12,245) | 145 ± 33 | 163 ± 31 | 125 ± 22 | <0.0001 |
| LV EDVi, mL/mm² (n = 12,155) | 77 ± 13 | 81 ± 14 | 72 ± 11 | <0.0001 |
| LV ESV, mL (n = 12,245) | 62 ± 18 | 72 ± 17 | 50 ± 12 | <0.0001 |
| LV ESVi, mL/mm² (n = 12,155) | 32 ± 8 | 36 ± 8 | 29 ± 6 | <0.0001 |
| LV EF, % (n = 12,245) | 58 ± 6 | 56 ± 6 | 59 ± 5 | <0.0001 |
| RV EDV, mL (n = 12,245) | 157 ± 38 | 180 ± 33 | 132 ± 24 | <0.0001 |
| RV EDVi, mL/mm² (n = 12,155) | 83 ± 15 | 89 ± 15 | 76 ± 12 | <0.0001 |
| RV ESV, mL (n = 12,245) | 68 ± 21 | 81 ± 19 | 55 ± 13 | <0.0001 |
| RV ESVi, mL/mm² (n = 12,155) | 36 ± 9 | 40 ± 9 | 31 ± 7 | <0.0001 |
| RV EF, % (n = 12,245) | 56 ± 6 | 55 ± 6 | 59 ± 6 | <0.0001 |

BP; blood pressure, HDL; high density lipoprotein, LV; left ventricle, RV; right ventricle, EDV; end-diastolic volume; EDVi end-diastolic volume indexed by BSA, ESV; end-systolic volume, ESVi; end-systolic volume indexed by BSA, EF; ejection fraction. P-values obtained by independent sampled T-test.

TABLE 2
Association between age and indices of biventricular structure and function.

| | standardized beta-coefficients (95% CI) | | | | |
|---|---|---|---|---|---|
| | n | Model 1 | | Model 2 | |
| Left Ventricle | | | | | |
| LV EDV | 12474 | −0.18 | (−0.19, −0.16)*** | −0.14 | (−0.28, −0.23)*** |
| LV ESV | 12474 | −0.14 | (−0.16, −0.12)*** | −0.11 | (−0.12, −0.10)*** |
| LV mass | 12474 | −0.07 | (−0.09, −0.05)*** | −0.08 | (−0.09, −0.06)*** |
| M/V ratio | 12474 | 0.16 | (0.14, 0.18)*** | 0.10 | (0.08, 0.12)*** |
| LVEF | 12474 | 0.03 | (0.01, 0.05)* | 0.01 | (−0.01, 0.03) |
| LV PER^{EDV} | 12133 | −0.03 | (−0.05, −0.01)** | −0.06 | (−0.08, −0.04)*** |
| LV PEFR^{EDV} | 12133 | −0.29 | (−0.31, −0.28)*** | −0.30 | (−0.32, −0.29)*** |
| Right Ventricle | | | | | |
| RV EDV | 12138 | −0.17 | (−0.19, −0.15)*** | −0.13 | (−0.15, −0.12)*** |
| RV ESV | 12138 | −0.18 | (−0.20, −0.16)*** | −0.14 | (−0.15, −0.13)*** |
| RV EF | 12138 | 0.10 | (0.08, 0.12)*** | 0.08 | (0.06, 0.10)*** |
| RV PER^{EDV} | 12138 | 0.06 | (0.04, 0.07)*** | −0.03 | (−0.05, −0.01)* |
| RV PEFR^{EDV} | 12138 | −0.20 | (−0.22, −0.18)*** | −0.22 | (−0.24, −0.20)*** |

Standardized regression beta-coefficients are shown, representing the z-score change in variables with increasing age. LV; left ventricle EDV; end-diastolic volume, ESV; end-systolic volume, EF; ejection fraction, PER^{EDV}; peak ejection rate standardized for EDV, PEFR^{EDV}; peak early filling rate standardized for EDV. Model 1 is unadjusted; Model 2 is adjusted for sex, height, weight, blood pressure at scan-time, heart rate at scan-time, LDL cholesterol, HDL cholesterol, hypertension, diabetes and smoking. *p<0.05, **p<0.001, ***p<0.00001.

Supplemental TABLE 1
Association between age and indices of biventricular structure
and function: Additional systolic and diastolic parameters.

| standardized beta-coefficients (95% CI) | | |
|---|---|---|
| n | Model 1 | Model 2 |

Left
Ventricle
systolic

| | | | | | |
|---|---|---|---|---|---|
| MAPSE | 10519 | −0.06 | (−0.08, −0.04)*** | −0.06 | (−0.09, −0.04)*** |
| ε^{circ} | 11983 | −0.09 | (−0.11, −0.07)*** | −0.22 | (−0.30, −0.14)*** |
| ε^{long} | 11978 | 0.03 | (0.01, 0.05)* | 0.13 | (0.04, 0.22)** |
| diastolic | | | | | |
| MAPDv | 12137 | 0.08 | (0.06, 0.10)*** | 0.08 | (0.06, 0.10)*** |
| ^{sr}e′^{circ} | 11934 | −0.01 | (−0.02, 0.00)* | −0.02 | (−0.02, −0.01)*** |
| ^{sr}e′^{long} | 11678 | −0.07 | (−0.09, −0.05)*** | −0.09 | (−0.17, −0.05)** |
| Right | | | | | |
| Ventricle | | | | | |
| systolic | | | | | |
| TAPSE | 10543 | 0.06 | (0.04, 0.07)*** | 0.05 | (0.02, 0.07)*** |
| ε^{long} | 11333 | −0.08 | (−0.13, −0.05)** | 0.08 | (−0.12, −0.10)*** |
| diastolic | | | | | |
| MAPDv | 9744 | 0.00 | (−0.02, 0.02) | 0.01 | (−0.02, 0.03) |
| ^{sr}e′^{long} | 10352 | −0.01 | (−0.03, 0.01) | −0.01 | (−0.02, 0.00)* |

Standardized regression beta-coefficients are shown, representing the z-score change in variables with increasing age. MAPSE; mitral annular plane systolic excursion, ε^{long}; peak longitudinal systolic strain ε^{circ}; peak circumferential systolic strain, PEFR^{EDV}; peak early filling rate standardized for EDV, TAPSE; tricuspid valve annular plane systolic excursion, MAPDv; mitral valve annular plane peak early diastolic velocity, TAPDv; tricuspid valve annular plane peak early diastolic velocity, ^{sr}ε′^{circ}; peak early diastolic circumferential strain rate, ^{sr}ε′^{long}; peak early diastolic longitudinal strain rate. Model 1 is unadjusted; Model 2 is adjusted for sex, height, weight, blood pressure at scan-time, heart rate at scan-time, LDL cholesterol, HDL cholesterol, hypertension, diabetes and smoking. *p<0.05, **p<0.001, ***p<0.00001.

Supplemental TABLE 2
Association between gender and risk factors and indices of left ventricular structure and function.

| | standardized beta-coefficients (95% CI) | | | | | | | | | |
|---|---|---|---|---|---|---|---|---|---|---|
| CV risk | Left ventricle | | | | | | | | | |
| factor | LV EDV | | LV EF | | M/V ratio | | LV PER^{EDV} | | LV PEFR^{EDV} | |
| Gender | −0.14 | (−0.15, −0.13)*** | −0.44 | (−0.50, −0.38)*** | 0.54 | (0.48, 0.60)*** | −0.02 | (−0.08, 0.03) | −0.37 | (−0.32, −0.29)*** |
| SBP at MRI | −0.01 | (−0.03, 0.00) | 0.00 | (−0.02, 0.02) | 0.01 | (−0.01, 0.03) | −0.01 | (−0.03, 0.01) | −0.02 | (−0.04, 0.00) |
| DBP at MRI | 0.01 | (−0.01, 0.02) | 0.01 | (−0.02, 0.03) | 0.01 | (−0.01, 0.02) | 0.01 | (−0.01, 0.04) | 0.01 | (−0.01, 0.03) |
| Hypertension | 0.03 | (0.01, 0.04)** | −0.03 | (−0.05, 0.00) | 0.09 | (0.07, 0.11)*** | 0.02 | (0.00, 0.04) | −0.01 | (−0.02, 0.01) |
| Diabetes | −0.04 | (−0.05, −0.02)*** | −0.03 | (−0.05, 0.00)* | 0.01 | (−0.01, 0.03) | 0.00 | (−0.03, 0.02) | −0.02 | (−0.04, −0.01)* |
| LDL | −0.05 | (−0.06, −0.04)*** | 0.00 | (−0.02, 0.02) | 0.06 | (0.05, 0.08)*** | 0.00 | (−0.02, 0.02) | −0.05 | (−0.06, −0.03)*** |
| Cholesterol | | | | | | | | | | |
| HDL | 0.11 | (0.09, 0.12)*** | 0.02 | (−0.01, 0.04) | −0.09 | (−0.11, −0.07)*** | −0.01 | (−0.03, 0.02) | 0.06 | (0.04, 0.08)*** |
| Cholesterol | | | | | | | | | | |
| Smoking | −0.02 | (−0.03, 0.00)* | −0.01 | (−0.03, 0.01) | 0.04 | (0.02, 0.05)*** | 0.01 | (−0.01, 0.03) | −0.01 | (−0.03, 0.01) |

Standardized regression beta-coefficients from the multivariate analysis are shown, representing the z-score change in variables with the associated factors. EDV; end-diastolic volume, PER^{EDV}; peak ejection rate standardized for EDV, PEFR^{EDV}; peak early filling rate standardized for EDV, SBP; systolic blood pressure at scan-time, DBP; diastolic blood pressure at scan-time. *p<0.05, **p<0.001, ***p<0.00001.

Supplemental TABLE 3
Association between gender and risk factors and indices of right ventricular structure and function.

| | standardized beta-coefficients (95% CI) | | | | | | | |
|---|---|---|---|---|---|---|---|---|
| | Right ventricle | | | | | | | |
| CV risk factor | RV EDV | | RV EF | | RV PER^{EDV} | | RV PEFR^{EDV} | |
| Gender | 0.67 | (0.62, 0.70)*** | −0.48 | (−0.54, −0.42)*** | 0.02 | (−0.03, 0.07) | −0.38 | (−0.24, −0.20)*** |
| SBP at MRI | −0.01 | (−0.02, 0.01) | 0.01 | (−0.01, 0.03) | 0.00 | (−0.02, 0.02) | −0.01 | (−0.03, 0.01) |
| DBP at MRI | 0.00 | (−0.01, 0.02) | 0.01 | (−0.02, 0.03) | 0.01 | (−0.01, 0.03) | 0.00 | (−0.02, 0.02) |
| Hypertension | 0.01 | (−0.01, 0.02) | 0.05 | (0.03, 0.07)*** | 0.06 | (0.04, 0.08)*** | −0.02 | (−0.04, 0.01) |
| Diabetes | −0.04 | (−0.06, −0.03)*** | 0.01 | (−0.02, 0.03) | −0.02 | (−0.04, 0.00)* | −0.03 | (−0.05, −0.01)** |
| LDL Cholesterol | −0.04 | (−0.05, −0.02)*** | 0.03 | (0.01, 0.05)** | 0.03 | (0.01, 0.05)** | −0.03 | (−0.05, −0.01)** |
| HDL Cholesterol | 0.08 | (0.07, 0.10)*** | 0.02 | (−0.00, 0.05) | 0.00 | (−0.02, 0.02) | 0.03 | (0.01, 0.05)* |
| Smoking | −0.02 | (−0.03, −0.01)* | 0.01 | (−0.01, 0.02) | 0.01 | (−0.01, 0.02) | −0.01 | (−0.03, 0.01) |

Standardized regression beta-coefficients from the multivariate analysis are shown, representing the z-score change in variables with the associated factors. EDV; end-diastolic volume, EF; ejection fraction, PER^{EDV}; peak ejection rate standardized for EDV, PEFR^{EDV}; peak early filling rate standardized for EDV, SBP; systolic blood pressure at scan-time, DBP; diastolic blood pressure at scan-time. *p<0.05, **p<0.001, ***p<0.00001.

APPENDIX B: CMR derived biomarkers of diastolic left ventricular function predict all-cause mortality at a population level.

### Background

Assessing left ventricular diastolic function using cardiac magnetic resonance (CMR) has long been challenging. However, recent advances in artificial intelligence based image-analysis enable automated extraction of a large set of biomarkers of diastolic function from cine CMR. It remains unknown whether these relate to outcome on a population level. We utilise our previously developed, fully-automated, quality-controlled pipeline for cine CMR analysis (AI-CMR^{QC}) to obtain biomarkers of LV diastolic function and investigate their association with outcome.

### Methods

This is a cross-sectional cohort study of the UK-Biobank population. The inventors analysed CMR scans of 39,584 subjects using AI-CMR^{QC} and performed survival analysis to relate the individual parameters of diastolic function (peak early filling rate; PEFR^{EDV}, peak diastolic mitral plane velocity; MAPDv and peak diastolic circumferential and longitudinal strain rate; ^{sr}e′^{long}) to overall mortality, univariately as well as after adjusting for cardiovascular riskfactors (CVrf) and patient characteristics. The inventors compared the survival association against conventional volumetric and systolic biomarkers and investigate the added value of markers of diastology in a regression model for risk prediction.

### Results

412 participants deceased during follow-up, resulting in a mortality-rate of 2.57 per 1,000 person-years. Decreased diastolic function was associated with a lower probability of survival for all diastolic biomarkers (p<0.0001 for all), including PEFR^{EDV} (hazard ratio 0.70) ^{sr}e′^{long} (hazard ratio 0.69). The associations remained significant after multivariate adjustment. The association with survival was stronger for diastolic biomarkers, as compared to systolic biomarkers (p<0.0001). Adding diastolic parameters into a regression model improved risk prediction significantly above the taking into account patient characteristics and conventional volumetric biomarkers obtained from CMR.

### Conclusions

Diastolic biomarkers obtained from automated CMR analysis using AI-CMR^{QC} are associated with survival at a population level and provide added value for risk prediction models. These finding suggest automated analysis of diastolic function provide a valuable addition to CMR exams.

### Introduction

The diastolic component of the cardiac cycle is of key importance to maintain appropriate cardiac function. It is the hallmark of heart failure with preserved ejection fraction and an independent predictor of outcome in systolic heart failure.

Even in people without overt heart disease, diastolic dysfunction has reportedly been seen frequently, with a link to increased mortality¹.

Despite the increasing attention for diastolic function, its assessment using CMR has remained challenging. Echocardiographic assessment of diastolic function is now well established2, but foreshortening and limited acoustic windows can restrict parameter estimation. CMR allows imaging of the heart without these restraints. Multiple measures of diastolic function could potentially be assessed from cine CMR: Diastolic ventricular volume dynamics, myocardial motion and strain, and mitral valve velocity can be quantified accurately. However, manual segmentation of the ventricles over the full cardiac cycle and semi-automated tracking of the myocardium remains time-consuming.

We have recently developed and validated an artificial intelligence (AI)-based quality-controlled (QC) framework for cine cardiac magnetic resonance (CMR) analysis (AI-CMR^{QC})³. AI-CMR^{QC} obtains human-level full cardiac cycle segmentation while simultaneously securing accuracy of output by detecting potential errors through a pre- and post-analysis quality-control process. This method allows us to calculate a detailed set of biomarkers of systolic and diastolic cardiac function (ventricular volume filling and ejection dynamics, feature tracking (FT) based myocardial systolic and strain (rate) and atrioventricular planar motion) automatically. Using AI-CMR^{QC} in a large population of 12,474 healthy subjects from the UK Biobank cohort, we have recently shown that a decline in diastolic function seems to be a major feature of cardiac aging (see Appendix A).

Whether CMR derived biomarkers of diastolic function show a relationship with outcome at a population level, similar to the association observed using echo-cardiography^{1,4}, remains unknown. This knowledge is essential to establish accurate grading systems of diastolic dysfunction, similar to the ones developed for echocardiography.

In this study, we investigate if and to what degree the different biomarkers of diastolic function are associated with survival at a population level. We analyse CMR scans of 39,584 subjects of the UK-Biobank population cohort. We compare diastolic biomarkers for association with survival among each other, as well as with systolic biomarkers and ventricular volumes to understand the potential importance of CMR based diastolic function biomarkers in assessing cardiac function.

### Methods

### Data Selection

UK Biobank (UKBB) is a community-based prospective population study of participants aged 40-85 years conducted in the United Kingdom⁵. A subsample of participants of the UKBB undergo CMR scans. At initiation of our study, first CMR scans were available for 39,571 subjects. Age, medical history, medication, height, weight and BMI were recorded for each subject. Heart rate and brachial systolic and diastolic blood pressure measured during CMR were also recorded.

UKBB received ethical approval from the National Health Service North West Centre for Research Ethics Committee (Ref: 11/NW/0382) and the National Information Governance Board for Health and Social and written consent was obtained from all participants.

### CMR Imaging and Biomarker Extraction

CMR was conducted during the third visit from 30 Apr. 2014 till March 2020 using a Siemens 1.5 Tesla MAGNETOM Aera scanner (Siemens, Erlangen, Germany) as previously described. We analysed the retrospective ECG-gated balanced Steady State Free Precession (bSSFP) cine short-axis stack and long-axis (2Ch, 4Ch) acquisitions using our AI-CMR^{QC} tool³. In short, our framework full-cardiac cycle segmentation of the left and right ventricular (LV and RV) blood pool and myocardium in all orientations using AI. It does not merely consist of an AI segmentation algorithm, but also employs robust pre- and post-analysis quality control (QC) steps that ensure the acquired images are of sufficient quality for analysis (pre-QC) and flags cases in whom the obtained volume and strain, and atrioventricular valve plane motion curves and obtained biomarkers show potential discrepancies or unphysiological behaviour for clinician review. This complete pipeline ensures automated analysis with a sensitivity of detecting erroneous results of 95%³.

The parameters obtained using AI-CMR^{QC} from short axis, 2-chamber and 4-chamber cine CMR scans were: left ventricular volumes at end-diastole (EDV) and end-systole (ESV), ejection fraction (EF), as well as peak ventricular ejection and peak ventricular filling rates (which were divided by EDV to eliminate the dependency on ventricular size; PER^{EDV}, PEFR^{EDV}), mitral valve annular plane systolic excursion (MAPSE) and peak early diastolic velocities (MAPDv), LV global longitudinal and LV global circumferential peak systolic myocardial strain (ε^{long} and ε^{circ}) and peak early diastolic strain rates (^{sr}e′^{circ} and ^{sr}e′^{long}).

### Outcome Measurements

Mortality information was obtained through the UK-Biobank's death summary report. This data includes time and primary cause of death (defined by ICD-10 codes) and is obtained by UK-Biobank through the National Health Service Information Centre as detailed online at https://biobank.ndph.ox.ac.uk/showcase/exinfo.cgi?src=Data_providers_and_date. Participant follow-up for mortality was censored on 28 Feb. 2021.

### Statistical Analysis

Data-analysis was performed using SPSS Statistics version 23 (IBM, USA). Data is expressed as mean±standard deviation (SD) and percentage for categorical variables. Missing values and outliers, defined a priori as values more than three interquartile ranges below the first quartile or above the third quartile, were excluded from further analysis. Association with outcome was explored for all LV diastolic parameters, systolic biomarkers and LV volumes.

The relationship between the biomarkers and overall mortality was investigated using univariate and multivariable Cox regression models. Subjects that were alive at the end of the follow-up period without having experienced a cardiovascular event (28 Feb. 2021) were treated as right censored. In multivariable Cox proportional hazards regression, adjustment was made for typical cardiovascular risk factors (diabetes, hypercholesterolemia, hypertension, SBP and DBP at CMR) and patient characteristics (height, weight and sex). All CMR parameters were standardized by conversion to z-scores prior to the regression analyses in order to compare the effects between the different parameters. All models were assessed for collinearity and proportional hazards assumption. Kaplan-Meier survival curves were plotted for outcome associated with high and low values of each biomarker, as defined by their median value. To compare the association with survival between biomarkers of diastolic and systolic function, independent T-tests were performed using the HR's and SD obtained using Cox proportional hazard regression models. Finally, the incremental prognostic value of diastolic biomarkers, beyond the patient characteristics, CVrf and conventional CMR parameters, was assessed in a nested Cox proportional hazard regression model. Using the increment in Chi-square score to determine improvement of the model. A p value <0.05 was considered statistically significant.

### Results

Participant characteristics are shown in Table 1. 39,584 subjects were included in the analysis. Mean age was 64.8±7.4 for men and 63.5±7.4 for women. Average systolic blood pressure, height, weight, proportion subjects with hypertension, hypercholesterolemia and diabetes mellitus were higher in men compared to women (each P<0.0001). Four participants were lost to follow-up. Mean duration of follow-up of participants was 4.0±1.5 years. 412 participants deceased between the imaging visit and the end of the follow-up period (270 men, 142 women). 73 deaths were of cardiac origin (52 men, 21 women) . The overall mortality-rate was 2.57 per 1,000 person-years.

### Diastology and Outcome

Decreased diastolic function was associated with a lower probability of survival for all diastolic biomarkers, see Table 2. PEFR^{EDV} (HR 0.70, CI 0.63-0.77), ^{sr}e′^{long} (HR 0.69 CI 0.62-0.78) and MAPDv (HR 0.70, CI 0.56-0.84) exhibited the strongest univariate association with survival.

Adjustment for height, weight, and CVrf's in multivariable Cox regression did not alter the observed associations between most the CMR parameters of diastolic function and survival, although it did modestly lower the hazard ratio estimates (see Table 2). Only for ^{sr}e′^{circ}, multivariate adjustment cancelled out the observed association with survival.

Kaplan-Meier curves for probability of event-free survival by high and low values of diastolic function are shown in FIG. 1. Log-rank testing confirmed a significant difference in event-free survival between the groups having low and high values of all diastolic parameters, with lower levels of diastolic function having a lower probability of event free survival compared to the group exhibiting high levels of diastolic function (P<0.001 for all).

### Systolic Biomarkers

Of the systolic parameters, MAPSE and PER^{EDV} were not associated with outcome in univariate analysis, see Table 2. LV EF (0.80, CI 0.73-0.87), ε^{circ} (HR 1.15, CI 1.04-1.28) and ε^{long} (HR 1.37, CI 1.24-1.52) were associated with survival. After multivariate adjustment, a modest decrease in hazard ratio estimates was observed, leaving only a significant association from ε^{long} and LV EF. Kaplan Meier curves for systolic parameters only showed significant differences in systolic metrics, stratified in low and high values for EF and ε^{long} (both log-rank: p<0.001).

### Added Value of Diastology

The Chi-square score of the nested cox regression model for survival prediction improved significantly beyond patient characteristics and conventional CMR parameters (LV EDV, ESV and EF), when LV PFR^{EDV}, MAPDv or ^{sr}e′^{long} were added (p<0.01 for all). ^{sr}e′^{circ} did not significantly improved model predictions beyond patient characteristics and conventional CMR parameters alone. FIG. 2 illustrates the increase in Chi-square for PEFR^{EDV}.

### Discussion

In this study we investigated the association between biomarkers of diastolic function obtained from CMR and mortality at a population level. To the best of our knowledge, this is the largest population study investigating the relationship between diastolic function from CMR and survival too date. We show that CMR derived parameters of diastolic function are independently associated with survival at a population level. Moreover, diastolic function was more important in determining survival in this cohort compared to systolic parameters. Our results demonstrate the feasibility of CMR based analysis of diastolic function using AI-CMR^{QC}, which shows similar associations to the ones obtained in population studies using echocardiography, and emphasizes the importance of analysing diastolic function, not only during overt cardiovascular disease4, but also in pre-clinical disease or healthy subjects aging with risk-factors.

Several proof-of-concept studies have demonstrated that analysis of diastolic function from cine CMR is feasible⁶. Unfortunately, analysing diastolic function from cine CMR has been time-consuming: to obtain diastolic metrics, ventricular volumes and valve position need to be segmented manually over the full cardiac cycle. As a result, CMR assessment of diastology has remained a niche.

Our AI-based method for cine CMR analysis, AI-CMR^{QC}, obtains a large range of parameters of systolic and diastolic function from short- and long-axis cine CMR, automated and using extensive quality-control. This way, diastolic function assessment becomes readily available. We have previously validated this method³, and used AI-CMR^{QC} to characterise biventricular changes in systolic and diastolic function during aging in a large cohort (see appendix A).

Our findings in the current study show that CMR derived metrics of diastolic function were strongly associated with survival, with HR around 0.70 (see Table 2). Correction for known factors of larger risk of diastolic dysfunction, such as age, diabetes and other CVrf, did not abolish the association between diastolic function and mortality. These findings are in keeping with earlier population studies using biomarkers of diastology obtained using echocardiography^{1,4,7}. We found that the association with mortality was present for all our obtained biomarkers, despite these measures being obtained from different aspects of cardiac diastolic phase (such as ventricular volume dynamics (PEFR), myocardial motion (strain) and atrioventricular valvar motion). Diastolic relaxation, in particular active early relaxation that is measured with the metrics obtained in this study, therefore seems to an important factor in maintaining adequate health.

We also found that the association with survival was significantly stronger for diastolic as compared to systolic measurements of cardiac function, even after correcting for patient characteristics and CVrf (Table 2). A similar observation was made in echo-based studies by Redfield et al.¹ and Shah et al.⁸. However these studies used a single metric (ejection fraction alone) to describe systolic function. Peak systolic longitudinal strain was the only ‘systolic’ biomarker with an association of similar magnitude to the diastolic parameters. However, previous research has suggested longitudinal LV systolic strain does not only reflect systolic, but also diastolic function^{9,10}. Despite being classified here as a systolic parameter, we can therefore not exclude that the observed association partly reflects its relation with diastolic function.

The metrics of diastology obtained from cine CMR differ to variable degrees from those obtained using echocardiography. CMR-derived strain is obtained from feature-, instead of speckle-tracking¹¹. Moreover, our measure of peak diastolic velocity of the mitral valve plane (MAPDv) is similar, but not directly comparable to tissue-doppler derived e′ in echocardiography. Despite these differences, our findings show similar strengths of association of the derived metrics to the ones observed in population studies utilising echocardiography^{1,4,7}. Indeed, previous proof-of-concept studies have shown the potential value of CMR derived indices of systolic and diastolic function, such as MAPSE¹², peak systolic and early diastolic circumferential and longitudinal strain¹³⁻¹⁵.

An additional parameter available from CMR is peak early ventricular filling rate (PEFR). When indexed for end-diastolic volume (PEFR^{EDV}), this measure had a strong association with survival, similar to those observed for MAPDv and longitudinal strain (see Table 2). This suggests it could be used as a potential additional marker of diastolic function from CMR.

In echocardiography, algorithms have been established to grade the severity of diastolic dysfunction from diastolic metrics^{2,16}. No such grading algorithm is yet available in CMR. We did not aim to derive a grading algorithm in our study, as no comparative data from echocardiography was available to inform such algorithm. However, by showing the strength of association for the individual metrics of diastolic function in the population, this study does aid development of a future grading system for CMR.

Diastolic dysfunction is becoming an increasingly important topic in cardiology. Nearly 50% of all patients experiencing HF symptoms, exhibit HF with preserved EF (HFpEF)^{17,18}. However, measuring diastolic dysfunction in a clinical setting is only useful when it can have consequences for patient care. RCT's of conventional heart failure treatments in patients with HFpEF have been disappointing¹⁹. However, recent evidence suggests that life-style changes can result in improvements of diastolic function and evasion of future symptomatic heart failure^{20,21}. Moreover, new treatments are emerging that potentially ameliorate diastolic dysfunction, such as empagliflozin²². Detection of diastolic dysfunction in a preclinical state, followed by targeted interventions is therefore likely to become an important practice in preventive cardiology. These developments necessitate easily-to-obtain, reliable measures of diastolic function. Our tool (AI-CMR^{QC}), which is fully-automated from CMR exam to report²³, and has been validated on UKBB³, as well as clinical CMR scans of all major vendors²⁴, enables such analysis in big datasets, as well as a routine clinical setting.

### Limitations

This study has several limitations. Firstly, the follow-up is relatively short in this population cohort (mean follow-up of 4 years). Despite this, a clear association between diastolic biomarkers and survival was found during this small follow-up. However, due to the relative small follow-up and incident rate, we were not able to analyse death stratified by origin (cardiac vs other) or by gender. Secondly, this is a cross-sectional study in a British population alone. Whether changes in diastolic function in individual patients are associated with changing survival, and whether these results are valid for other populations has to be subject of further studies. Thirdly, it cannot be ruled out that the practical process of attending to and undergoing a CMR scan might have introduced some selection in the population towards healthier subjects. Lastly, separate studies must be performed to evaluate the prognostic value of diastolic parameters in patients with cardiac diseases.

### Conclusion

We showed that diastolic biomarkers obtained from automated CMR analysis using AI-CMR^{QC} are associated with survival at a population level and their impact is larger compared to metrics of systolic function. The strength of these associations supports the use of CMR to quantify diastolic function and, and this work provides a step towards developing grading algorithms for (early screening of) diastolic dysfunction using CMR.

### REFERENCES

1. Redfield M M, Jacobsen S J, Burnett J C, Mahoney D W, Bailey K R, Rodeheffer R J. Burden of Systolic and Diastolic Ventricular Dysfunction in the Community. Jama 2003; 289: 194.
2. Nagueh S F, Smiseth O A, Appleton C P, Byrd B F, Dokainish H, Edvardsen T, Flachskampf F A, Gillebert T C, Klein A L, Lancellotti P, Marino P, Oh J K, Popescu BA, Waggoner AD. Recommendations for the Evaluation of Left Ventricular Diastolic Function by Echocardiography: An Update from the American Society of Echocardiography and the European Association of Cardiovascular Imaging. J Am Soc Echocardiogr Elsevier Inc; 2016; 29:277-314.
3. Ruijsink B, Puyol-Antón E, Oksuz I, Sinclair M, Bai W, Schnabel J A, Razavi R, King A P. Fully Automated, Quality-Controlled Cardiac Analysis From CMR: Validation and Large-Scale Application to Characterize Cardiac Function. JACC Cardiovasc Imaging Elsevier Inc.; 2020; 13:684-695.
4. Nauta J F, Hummel Y M, Meer P van der, Lam C S P, Voors A A, Melle J P van. Correlation with invasive left ventricular filling pressures and prognostic relevance of the echocardiographic diastolic parameters used in the 2016 ESC heart failure guidelines and in the 2016 ASE/EACVI recommendations: a systematic review in patients wi. Eur J Heart Fail 2018;20:1303-1311.
5. Allen N E, Sudlow C, Peakman T, Collins R. UK biobank data: Come and get it. Sci Transl Med 2014;6:4-7.
6. Chamsi-Pasha M A, Zhan Y, Debs D, Shah D J. CMR in the Evaluation of Diastolic Dysfunction and Phenotyping of HFpEF: Current Role and Future Perspectives. JACC Cardiovasc Imaging Elsevier; 2020; 13:283-296.
7. AlJaroudi W A, Alraies M C, Halley C, Menon V, Rodriguez L L, Grimm R A, Thomas J D, Jaber W A. Incremental prognostic value of diastolic dysfunction in low risk patients undergoing echocardiography: Beyond Framingham score. Int J Cardiovasc Imaging 2013; 29:1441-1450.
8. Shah A M, Claggett B, Sweitzer N K, Shah S J, Anand I S, O'Meara E, Desai A S, Heitner J F, Li G, Fang J, Rouleau J, Zile M R, Markov V, Ryabov V, Reis G, Assmann S F, Mckinlay S M, Pitt B, Pfeffer M A, Solomon S D. Cardiac structure and function and prognosis in heart failure with preserved ejection fraction. Circ Hear Fail 2014;7:740-751.
9. Hasselberg N E, Haugaa K H, Sarvari S I, Gullestad L, Andreassen A K, Smiseth O A, Edvardsen T. Left ventricular global longitudinal strain is associated with exercise capacity in failing hearts with preserved and reduced ejection fraction. Eur Heart J Cardiovasc Imaging 2015; 16:217-224.
10. Yu B, Lin I, Cornish B, Lin K, Park L, Perla G, Lin S. Relationship Between Global Longitudinal Strain and Left Ventricular Diastolic Function. J Am Coll Cardiol American College of Cardiology Foundation; 2019; 73:1675.
11. Pedrizzetti G, Claus P, Kilner P J, Nagel E. Principles of cardiovascular magnetic resonance feature tracking and echocardiographic speckle tracking for informed clinical use. J Cardiovasc Magn Reson BioMed Central; 2016; 18:51.
12. Romano S, Judd R M, Kim R J, Kim H W, Heitner J F, Shah D J, Devereux R B, Salazar P, Trybula M, Chia R C, Evans K, Farzaneh-Far A. Prognostic Implications of Mitral Annular Plane Systolic Excursion in Patients with Hypertension and a Clinical Indication for Cardiac Magnetic Resonance Imaging: A Multicenter Study. JACC Cardiovasc Imaging 2019; 12: 1769-1779.
13. Nazir S A, Shetye A M, Khan J N, Singh A, Arnold J R, Squire I, McCann G P. Inter-study repeatability of circumferential strain and diastolic strain rate by CMR tagging, feature tracking and tissue tracking in ST-segment elevation myocardial infarction. Int J Cardiovasc Imaging Springer Netherlands; 2020;36:1133-1146.
14. Everdingen W M van, Zweerink A, Nijveldt R, Salden O A E, Meine M, Maass A H, Vernooy K, Lange F J De, Rossum A C van, Croisille P, Clarysse P, Geelhoed B, Rienstra M, Gelder I C Van, Vos M A, Allaart C P, Cramer M J. Comparison of strain imaging techniques in CRT candidates: CMR tagging, CMR feature tracking and speckle tracking echocardiography. Int J Cardiovasc Imaging Springer Netherlands; 2018; 34:443-456.
15. Romano S, Judd R M, Kim R J, Heitner J F, Shah D J, Shenoy C, Evans K, Romer B, Salazar P, Farzaneh-Far A. Feature-Tracking Global Longitudinal Strain Predicts Mortality in Patients With Preserved Ejection Fraction: A Multicenter Study. JACC Cardiovasc Imaging 2020; 13:940-947.
16. Sato K, Grant A D M, Negishi K, Cremer P C, Negishi T, Kumar A, Collier P, Kapadia S R, Grimm R A, Desai M Y, Griffin B P, Popović Z B. Reliability of updated left ventricular diastolic function recommendations in predicting elevated left ventricular filling pressure and prognosis. Am Heart J Mosby; 2017; 189:28-39.
17. Aurigemma G P, Gottdiener J S, Shemanski L, Gardin J, Kitzman D. Predictive value of systolic and diastolic function for incident congestive heart failure in the elderly: The cardiovascular health study. J Am Coll Cardiol Elsevier Masson SAS; 2001;37:1042-1048.
18. Owan T E, Hodge D O, Herges R M, Jacobsen S J, Roger V L, Redfield M M. Trends in Prevalence and Outcome of Heart Failure with Preserved Ejection Fraction. N Engl J Med 2006; 355:251-259.
19. Chetrit M, Cremer P C, Klein A L. Imaging of Diastolic Dysfunction in Community-Based Epidemiological Studies and Randomized Controlled Trials of HFpEF. JACC Cardiovasc Imaging Elsevier; 2020; 13:310-326.
20. Nayor M, Enserro D M, Xanthakis V, Larson M G, Benjamin E J, Aragam J, Mitchell G F, Vasan R S. Comorbidities and Cardiometabolic Disease: Relationship With Longitudinal Changes in Diastolic Function. JACC Hear Fail 2018;6:317-325.
21. Leclerc J, Arsenault M, Després J-P, Brassard P, Gaudreault V, Bergeron J, Alméras N, Tremblay A, Auclair A, Ross M-K, Denault-Bissonnette S, Poirier P. Determinants of Improvement In Left Ventricular Diastolic Function Following a 1-Year Lifestyle Modification Program in Abdominally Obese Men with Features of the Metabolic Syndrome. Metab Syndr Relat Disord United States; 2016; 14:483-491.
22. Santos-Gallego C G, Requena-Ibanez J A, San Antonio R, Garcia-Ropero A, Ishikawa K, Watanabe S, Picatoste B, Vargas-Delgado A P, Flores-Umanzor E J, Sanz J, Fuster V, Badimon J J. Empagliflozin Ameliorates Diastolic Dysfunction and Left Ventricular Fibrosis/Stiffness in Nondiabetic Heart Failure: A Multimodality Study. JACC Cardiovasc Imaging 2021; 14:393-407.
23. Vergani V, Razavi R, Puyol-Antón E, Ruijsink B. Deep Learning for Classification and Selection of Cine CMR Images to Achieve Fully Automated Quality-Controlled CMR Analysis From Scanner to Report. Front Cardiovasc Med 2021;8.
24. Mariscal Harana J, Vergani V, Asher C, Razavi R, King A, Ruijsink B, Puyol Anton E. Large-scale, multi-vendor, multi-protocol, quality-controlled analysis of clinical cine CMR using artificial intelligence. Eur Hear Journal-Cardiovascular Imaging Oxford University Press; 2021;22:jeab090—046.

TABLE 1
Patient Characteristics

| | Total | | Male | | Female | | |
|---|---|---|---|---|---|---|---|
| | Cohort | | Participants | | Participants | | |
| Characteristics | (n = 39,584) | | (n = 20,582) | | (n = 19,002) | | P-value |
| All Death, n(%) (n = 39,580) | 412 | (1%) | 270 | (1.3%) | 142 | (0.7%) | <.0001 |
| Cardiac Death, n(%) (n = 39,580) | 73 | (0.1%) | 52 | (0.2%) | 21 | (0.1%) | <.001 |
| Age, years (n = 39,571) | 64.1 ± 7.6 | | 64.8 ± 7.4 | | 63.5 ± 7.4 | | <0.0001 |
| Height, cm (n = 39,546) | 169.7 ± 9.1 | | 177.5 ± 6.5 | | 163.3 ± 6.6 | | <0.0001 |
| Weight, kg (n = 39,530) | 76.8 ± 14.9 | | 84.6 ± 12.7 | | 69.6 ± 12.7 | | <0.0001 |
| BMI (n = 39,530) | 26.6 ± 4.2 | | 27.1 ± 3.8 | | 26.1 ± 4.6 | | <0.0001 |
| BSA (n = 39,526) | 1.87 ± 0.2 | | | | | | |
| Hypertension, % (n = 39,584) | 11,975 | (30.3) | 6,981 | (36.7) | 4,994 | (24.3) | <0.0001 |
| Hyperlipaemia, % (n = 39,584) | 10,221 | (25.8) | 6,528 | (34.4) | 3,693 | (17.9) | <0.0001 |
| Diabetes mellitus, % (n = 39,584) | 2,100 | (5.3) | 1,351 | (7.1) | 749 | (3.6) | <0.0001 |

| | | | | |
|---|---|---|---|---|
| Systolic BP, mmHg (n = 36,785) | 136.9 ± 18.7 | 140.8 ± 17.5 | 133.3 ± 19.1 | <0.0001 |
| Diastolic BP, mmHg (n = 36,785) | 81.4 ± 10.4 | 83.6 ± 10.2 | 79.4 ± 10.2 | 0.284 |
| Ventricular volumes | | | | |
| LV EDV, ml (n = 38,934) | 143.0 ± 34.6 | 163.6 ± 33.2 | 124.1 ± 23.3 | <0.0001 |
| LV ESV, ml (n = 38,934) | 59.5 ± 20.3 | 71.0 ± 20.6 | 49.0 ± 13.0 | <0.0001 |
| Diastolic LV function | | | | |
| LV PEFR, ml/s (n = 38,903) | 2.27 ± 0.66 | 2.08 ± 0.62 | 2.44 ± 0.66 | <0.001 |
| MAPDv, mm/s (n = 37,426) | 47.0 ± 19.8 | 45.9 ± 19.6 | 48.1 ± 19.9 | <0.001 |
| ^{sr}e′^{circ} (n = 37,667) | 1.21 ± 0.41 | 1.13 ± 0.42 | 1.30 ± 0.39 | <0.001 |
| ^{sr}e′^{long} (n = 36,576) | 1.07 ± 0.39 | 0.98 ± 0.38 | 1.15 ± 0.38 | <0.001 |
| Systolic LV function | | | | |
| LV EF, % (n = 38,934) | 58.9 ± 6.7 | 56.8 ± 6.7 | 61 ± 6.2 | <0.001 |
| PER, ml/s (n = 38,923) | 2.65 ± 0.65 | 2.69 ± 0.64 | 2.61 ± 0.66 | <0.001 |
| MAPSE, mm (n = 36,130) | 10.0 ± 3.9 | 10.1 ± 4.1 | 10.0 ± 3.8 | 0.014 |
| ε^{circ} (n = 37,853) | −22.5 ± 3.8 | −21.6 ± 3.7 | −23.4 ± 3.6 | <0.001 |
| ε^{long} (n = 36,636) | −21.1 ± 3.7 | −19.9 ± 3.6 | −22.2 ± 3.5 | <0.001 |

Mean±SD and frequencies (%) are displayed. P-values represent unpaired T-test and chi-squared test for continuous and bivariate data respectively, for comparison between female and male participants. LV; left ventricle, EDV; end-diastolic volume, ESV; end-systolic volume, peak circumferential systolic strain, PEFR^{EDV}; peak early filling rate standardized for EDV, MAPDv; mitral valve annular plane peak early diastolic velocity, ^{sr}e′^{circ}; peak early diastolic circumferential strain rate, ^{sr}e′^{long}; peak early diastolic longitudinal strain rate, EF; ejection fraction, MAPSE; mitral annular plane systolic excursion, ε^{long}; peak longitudinal systolic strain, ε^{circ}; peak circumferential systolic strain, BP; blood pressure.

TABLE 2
Hazard ratio's for the association between
LV function and all-cause mortality.

| | Univariate | | Multivariate | |
|---|---|---|---|---|
| Variable | analysis | p -value | analysis | p-value |
| LV volumes | | | | |
| LVEDV | 1.17 (1.06-1.28) | 0.001 | 0.96 (0.86-1.08) | 0.514 |
| LVESV | 1.23 (1.15-1.33) | <.001 | 1.10 (1.01-1.22) | 0.04 |
| Diastolic | | | | |
| LV function | | | | |
| LV PEFR | 0.70 (0.63-0.77) | <.001 | 0.80 (0.72-0.90) | <.001 |
| MAPDv | 0.70 (0.56-0.84) | <.001 | 0.78 (0.64-0.90) | <.001 |
| ^{sr}e′^{circ} | 0.80 (0.70-0.92) | 0.002 | 0.88 (0.78-1.01) | 0.071 |
| ^{sr}e′^{long} | 0.69 (0.62-0.78) | <.001 | 0.79 (0.69-0.91) | <.001 |
| Systolic | | | | |
| LV function | | | | |
| LV EF | 0.80 (0.73-0.87) | <.001 | 0.85 (0.78-0.94) | 0.001 |
| LV PER | 0.96 (0.87-1.06) | 0.446 | 0.94 (0.85-1.04) | 0.237 |
| MAPSE | 0.99 (0.90-1.10) | 0.853 | 0.92 (0.91-1.12) | 0.915 |
| ε^{circ} | 1.15 (1.04-1.28) | 0.007 | 1.12 (1.01-1.24) | 0.031 |
| ε^{long} | 1.37 (1.24-1.52) | <.001 | 1.23 (1.10-1.38) | <.001 |

Hazard ratio's with confidence interval and obtained p-value for the association with all-cause mortality in the total population for uni- and multivariable cox-regression. The multivariable model was adjusted for sex, height, weight, blood pressure at scan-time, heart rate at scan-time, LDL cholesterol, HDL cholesterol, hypertension, diabetes and smoking. LV; left ventricle EDV; end-diastolic volume, ESV; end-systolic volume, EF; ejection fraction, PER^{EDV}; peak ejection rate standardized for EDV, PEFR^{EDV}; peak early filling rate standardized for EDV. Model 1 is unadjusted; Model 2 is adjusted for sex, height, weight, blood pressure at scan-time, heart rate at scan-time, LDL cholesterol, HDL cholesterol, hypertension, diabetes and smoking.

1. A computer-implemented method for characterizing images of a target area of the internal anatomy of a human or animal subject, the images having been obtained using a medical imaging modality, the method comprising:
providing a plurality of images of the target area obtained using the medical imaging modality;
performing a first quality control check on the plurality of images, wherein the quality control check comprises:
(i) classifying the plurality of images into one or more classes based on predefined metadata associated with each image; and
(ii) screening the classified images, based on image quality and image orientation, to select a first set of images for analysis,
wherein the method further comprises analysing the selected first set of images to evaluate one or more characteristics associated with the said target area as discernible from the selected first set of images, and
wherein the method comprises the use of one or more deep learning (DL) algorithms.

2. A computer-implemented method according to claim 1 wherein the method further comprises a second, post-analysis, quality control step comprising screening the analysed images based on image orientation and coverage of the target area in the analysed image.

3. A computer-implemented method according to claim 1, wherein the one or more DL algorithms comprise: Convolutional Neural Network (CNN), Fully Convolutional Network (FCN), CNN-Long short term memory (LSTM) network, and no-new-net (nnU-net) network.

4. A computer-implemented method according claim 1, wherein the medical imaging modality is selected from a group comprising radiography, fluoroscopy, angiography, mammography, computed tomography, ultrasound and magnetic resonance imaging (MRI).

5. A computer-implemented method according to claim 4, wherein the medical imaging modality is cardiovascular magnetic resonance imaging (CMR).

6. A computer-implemented method according to claim 5 wherein the plurality of images comprise cine CMR images of the heart of the human or animal subject.

7. A computer-implemented method according to claim 6 wherein the one or more classes is based on cardiac imaging planes used in cine CMR.

8. A computer-implemented method according to claim 7 wherein, in the first quality control check, the screening based on image quality comprises screening the classified images for motion artefacts.

9. A computer implemented method according to claim 7 wherein, in the first quality control check, the screening based on image orientation comprises screening the classified images for off-axis orientations.

10. A computer-implemented method according to claim 8 wherein, in the first quality control check, the said screening is performed using a binary classifier.

11. A computer implemented method according to claim 5, wherein the one or more characteristics associated with the target area comprise cardiac biomarkers.

12. A computer-implemented method according to claim 5, wherein analysing the selected first set of images comprises segmenting left ventricle and right ventricle areas in the first set of images using a DL algorithm.

13. A computer-implemented method according to claim 12 wherein the said segmenting is performed using a no-new-net (nnU-net) network.

14. A computer-implemented method according to claim 13 wherein the one or more characteristics associated with the target area comprise cardiac biomarkers including Mitral and tricuspid valve annular plane systolic excursion (MAPSE and TAPSE) biomarkers and early diastolic velocities (MAPDv, TAPDv) biomarkers.

15. A computer-implemented method according to claim 5, wherein post-analysis quality control step is performed using a CNN-LSTM network.

16. A computer-implemented method according to claim 15 wherein the CNN-LSTM network is configured to receive the full cardiac cycle as input and detect unphysiological curves in the analysed images.

17. A system for characterizing images of a target area of the internal anatomy of a human or animal subject, the images having been obtained using a medical imaging modality, wherein the system comprises a processor and processor readable instructions configured to cause the processor in use to:
receive a plurality of images of the target area obtained using the medical imaging modality;
perform a first quality control check on the plurality of images, wherein the quality control check comprises:
(i) classifying the plurality of images into one or more classes based on predefined metadata associated with each image; and
(ii) screening the classified images, based on image quality and image orientation, to select a first set of images for analysis,
the processor being further configured to analyse the selected first set of images to evaluate one or more characteristics associated with the said target area as discernible from the selected first set of images, and
wherein the analysis comprises the use of one or more deep learning (DL) algorithms.

18. A system according to claim 17, wherein the processor is further configured to undertake a second, post-analysis, quality control step comprising screening the analysed images based on image orientation and coverage of the target area in the analysed image.

19. A system according to claim 17 wherein the medical imaging modality is cardiovascular magnetic resonance imaging (CMR).

20. A system according to claim 19, wherein the plurality of images comprise cine CMR images of the heart of the human or animal subject, wherein the one or more classes is based on cardiac imaging planes used in cine CMR, and wherein, in the first
